(19) United States
(12) Patent Application Publication
(10) Pub. No.: US 2013/0080344 A1
(43) Pub. Date: Mar. 28, 2013

(54) ESTIMATING PROCESS AND SYSTEM

(71) Applicants: Alan Richard JONES, Warton (GB); Francis John Berry, Warton (GB); Sarah Lindsay Hiles, Warton (GB); Keith Andrews, Warton (GB)

(72) Inventors: Alan Richard JONES, Warton (GB); Francis John Berry, Warton (GB); Sarah Lindsay Hiles, Warton (GB); Keith Andrews, Warton (GB)

(73) Assignee: BAE SYSTEMS plc, London (GB)

(21) Appl. No.: 13/624,618

(22) Filed: Sep. 21, 2012

(30) Foreign Application Priority Data
Sep. 22, 2011 (GB) 1116386.2

(51) Int. Cl. G06Q 99/00

(52) U.S. Cl. 705/317

(57) ABSTRACT

Processes and apparatus are disclosed for determining how mature an estimate is by assessing the basis of an estimate against a scale of criteria or categories of plural relative values of maturity of estimate. Confidence levels derived for two different estimating processes for a same estimate, can be reconciled; and an estimating process can be controlled by systematically reviewing the readiness of a planned estimating process by reviewing the basis of the estimate by assessment of determined maturity level values in a document register. An estimating process can also be controlled by controlling the iterative performance of different estimate assessment and/or preparation processes dependent upon a maturity of a basis of the estimate.

### FIELD OF THE INVENTION

The present invention relates to processes and systems for estimating the costs of processes and/or products and/or services. The present invention relates in particular to, but is not limited to, estimating the costs of technical processes, for example developing and/or modifying and/or building technical products, for example aircraft, ships, aircraft control systems, ship control systems, and so on.

### BACKGROUND

Processes and systems for estimating the costs of processes (and/or products and/or services), for example estimating the costs of technical processes, for example developing and/or modifying and/or building technical products, for example aircraft, ships, aircraft control systems, ship control systems, and so on, are known. Typically, such known approaches simply take a snapshot approach to determining an estimate. This may be updated by repeating (effectively in isolation from the original process) the whole process or parts of the process.

Conventional estimating approaches do not rigorously assess, before embarking on the main part of the estimating approach, nor during the estimating approach, the extent to which the estimate is/will be mature/fully informed. In other words, prior to embarking on the main part of the estimate process, conventional approaches fail to implement, or only achieve to a limited extent, rigorous assessment and resulting modification of key aspects that will influence the estimate process throughout its life. This also applies to changes that arise during the course of the estimating process, in particular with regard to adapting the ongoing process in the light of the ongoing findings.

More generally, conventional approaches fail to provide an ongoing estimation process that incorporates the above aspects, and other known estimating tools, in a fully integrated and controlled system and approach that provides heightened levels of flexibility whilst nevertheless maintaining control and accountability (of, for example, authentication, assessment and control of the validity of the basis for the estimate as this changes during the ongoing integrated process).

It is known to provide top down estimates and/or bottom up estimates. It is also known to assess the resulting baseline estimates in terms of uncertainty, risk, and opportunity. It is known to apply Monte Carlo techniques to top down baseline estimates to provide plots of confidence level. It is known to determine confidence level values for bottom up baseline estimates. However, known approaches fail to adequately reconcile plots of confidence levels from top down estimates with confidence levels from bottom up estimates.

### SUMMARY OF THE INVENTION

In various aspects the present invention provides processes and apparatus for determining how mature an estimate is by assessing the basis of an estimate against a scale of criteria or categories of plural relative values of maturity of estimate. Also processes and apparatus for reconciling respective confidence levels derived for two different estimating processes for a same estimate. Also processes and apparatus for controlling an estimating process by systematically reviewing the readiness of a planned estimating process by reviewing the basis of the estimate by assessment of determined maturity level values in a document register. Also processes and apparatus for controlling an estimating process by controlling the iterative performance of a plurality of different estimate assessment and/or preparation processes dependent upon a maturity of a basis of the estimate.

In a further aspect, the present invention provides apparatus for use in determining how mature an estimate is by assessing the basis of an estimate against a scale of criteria or categories of plural relative values of maturity of estimate; the apparatus comprising: a data store configured to store data defining the criteria or categories and data identifying plural relative values of maturity of estimate, in a manner that provides a correlation between respective defined criteria or categories and respective values of the plural relative values; and an input/output operatively coupled to the data store and configured to provide the stored data to an operator and further configured to accept selection input from the operator of one of the plural relative values.

In a further aspect, the present invention provides a method of determining how mature an estimate is, comprising: assessing, by an estimating system comprising a computer network, the basis of an estimate against a scale of criteria or categories of plural relative values of maturity of estimate.

In a further aspect, the present invention provides apparatus for reconciling respective confidence levels derived for two different estimating processes for a same estimate, the apparatus comprising one or more processors configured to: fit a confidence level curve derived from assessment of a first estimating process of a first type to a single or limited number of confidence level points derived from assessment of a second estimating process of a second type, the second estimating process type being different to the first estimating process type.

In a further aspect, the present invention provides a method of reconciling respective confidence levels derived for two different estimating processes for a same estimate, the method comprising: fitting, by an estimating system comprising a computer network, a confidence level curve derived from assessment of a first estimating process of a first type to a single or limited number of confidence level points derived from assessment of a second estimating process of a second type, the second estimating process type being different to the first estimating process type.

In a further aspect, the present invention provides apparatus for use in controlling an estimating process by systematically reviewing the readiness of a planned estimating process by systematically reviewing the basis of the estimate by assessment of determined maturity level values in a document register; the apparatus comprising: a data store configured to store data defining the document register; and an input/output operatively coupled to the data store and configured to receive data for the document register and further configured to output data from the document register.

In a further aspect, the present invention provides a method of controlling an estimating process, the controlling method comprising: systematically reviewing the readiness of a planned estimating process, the reviewing comprising systematically reviewing the basis of the estimate by assessment of determined maturity level values in a document register; and responsive to the planned estimating process being determined as being insufficiently ready, changing the estimating plan of the estimate; the controlling method performed by an estimating system comprising a computer network.

In a further aspect, the present invention provides apparatus for controlling an estimating process; the apparatus comprising one or more processors configured to: iteratively perform a plurality of different estimate assessment and/or preparation processes; and control the iteration dependent upon a maturity of the basis of the estimate wherein controlling the iteration comprises one or more of the group consisting of: (i) performing a differing selection of a plurality of estimate assessment and/or preparation processes compared to a previous iteration; and (ii) performing one or more of the plurality of estimate assessment and/or preparation processes in a modified way compared to how it was performed in a previous iteration.

In a further aspect, the present invention provides a method of controlling an estimating process, the controlling method comprising: iteratively performing a plurality of different estimate assessment and/or preparation processes; controlling the iteration dependent upon a maturity of the basis of the estimate wherein controlling the iteration comprises one or more of the group consisting of: (i) performing a differing selection of a plurality of estimate assessment and/or preparation processes compared to a previous iteration; and (ii) performing one or more of the plurality of estimate assessment and/or preparation processes in a modified way compared to how it was performed in a previous iteration; the controlling method performed by an estimating system comprising a computer network.

### BRIEF DESCRIPTION OF THE DRAWINGS

FIG. 1 is a schematic block diagram representation of an estimating system;

FIG. 2 is a process flowchart showing certain steps of an estimating process that may be implemented using the estimating system of FIG. 1;

FIG. 3 is a process flowchart showing certain steps performed by a plan and manage module;

FIG. 4 is a process flowchart showing certain steps performed by a top down module 200;

FIG. 5 is a process flowchart showing certain steps performed by a bottom up module;

FIG. 6 is a process flowchart showing certain steps performed by a risk, opportunity and uncertainty module;

FIG. 7 is a process flowchart showing certain steps performed in implementing a reconciling process;

FIG. 8 is a schematic (not to scale) representation of a hypothetical example of a fitting of a cumulative probability density function of a Monte Carlo output from a bottom up evaluation of risk, opportunity and uncertainty to a value (of confidence level) from a top down variability evaluation;

FIG. 9 is a schematic and simplified representation of a document register; and

FIG. 10 is a simplified block diagram schematically illustrating a server-based computer network.

### DETAILED DESCRIPTION

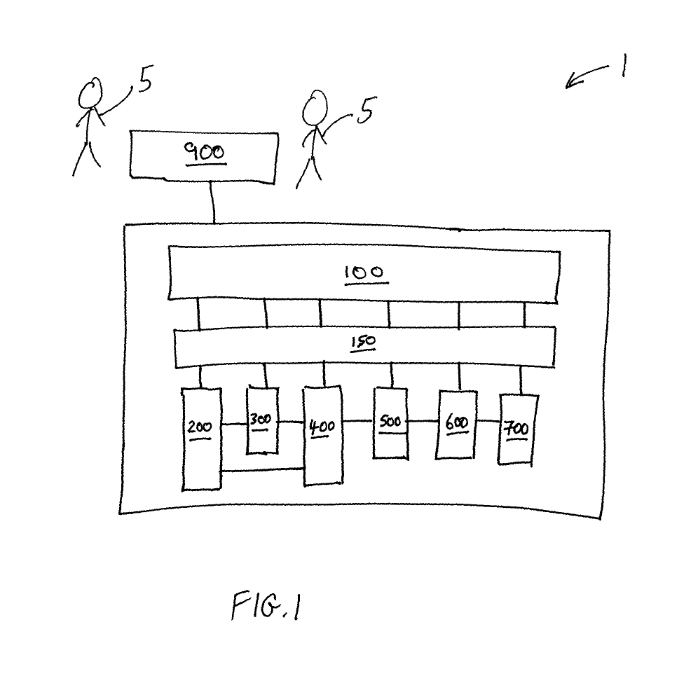

FIG. 1 is a schematic block diagram representation of a first embodiment of an estimating system 1.

The estimating system 1 comprises the following functional modules: a plan and manage module 100, a decision module 150, a top down module 200, a bottom up module 300, a validate or challenge module 400, a risk, opportunity and uncertainty module 500, a reconcile and maintain module 600, and a clearance module 700. The estimating system 1 further comprises an operator input/output 900 and operators 5.

The plan and manage module 100 is coupled to the decision module 150. Also, although not shown, the plan and manage module may be additionally coupled directly to each of the top down module 200, the bottom up module 300, the validate or challenge module 400, the risk, opportunity and uncertainty module 500, the reconcile and maintain module 600, and the clearance module 700.

The decision module is further coupled to each of the top down module 200, the bottom up module 300, the validate or challenge module 400, the risk, opportunity and uncertainty module 500, the reconcile and maintain module 600, and the clearance module 700.

The top down module 200 is further coupled to the bottom up module 300 and to the validate or challenge module 400. The bottom up module 300 is further coupled to the validate or challenge module 400. The top down module 200, bottom up module 300 and the validate or challenge module 400 are all further coupled to the risk, opportunity and uncertainty module 500 (for clarity this is not shown in FIG. 1). The risk, opportunity and uncertainty module 500 is further coupled to the reconcile and maintain module 600. The reconcile and maintain module 600 is further coupled to the clearance module 700.

In operation, operator inputs from one or more operators 5 are received by the above described modules of the estimating system 1 from the operator input/output 900. Also, outputs are provided from the above described modules of the estimating system 1 to one or more operators 5 via operator input/output 900. The operator input/output 900 may be coupled to any appropriate module of the estimating system 1 as required. For example, all such couplings may be via the plan and manage module 100 and/or the decision module 150. However, this need not be the case, and in other embodiments there may be one or more direct couplings between the input/output 900 and any one or more of the different modules 100, 150, 200-700 of the estimating system 1.

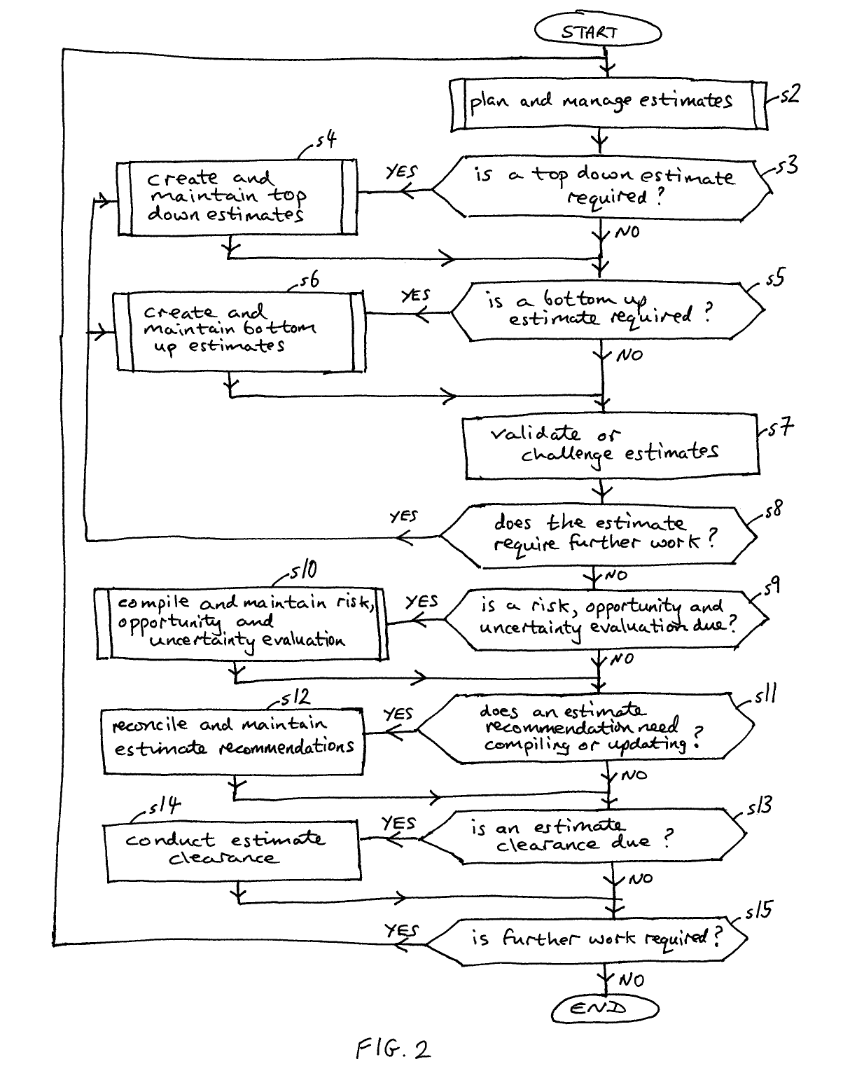

FIG. 2 is a process flowchart showing certain steps of an embodiment of an estimating process that may be implemented using the estimating system 1.

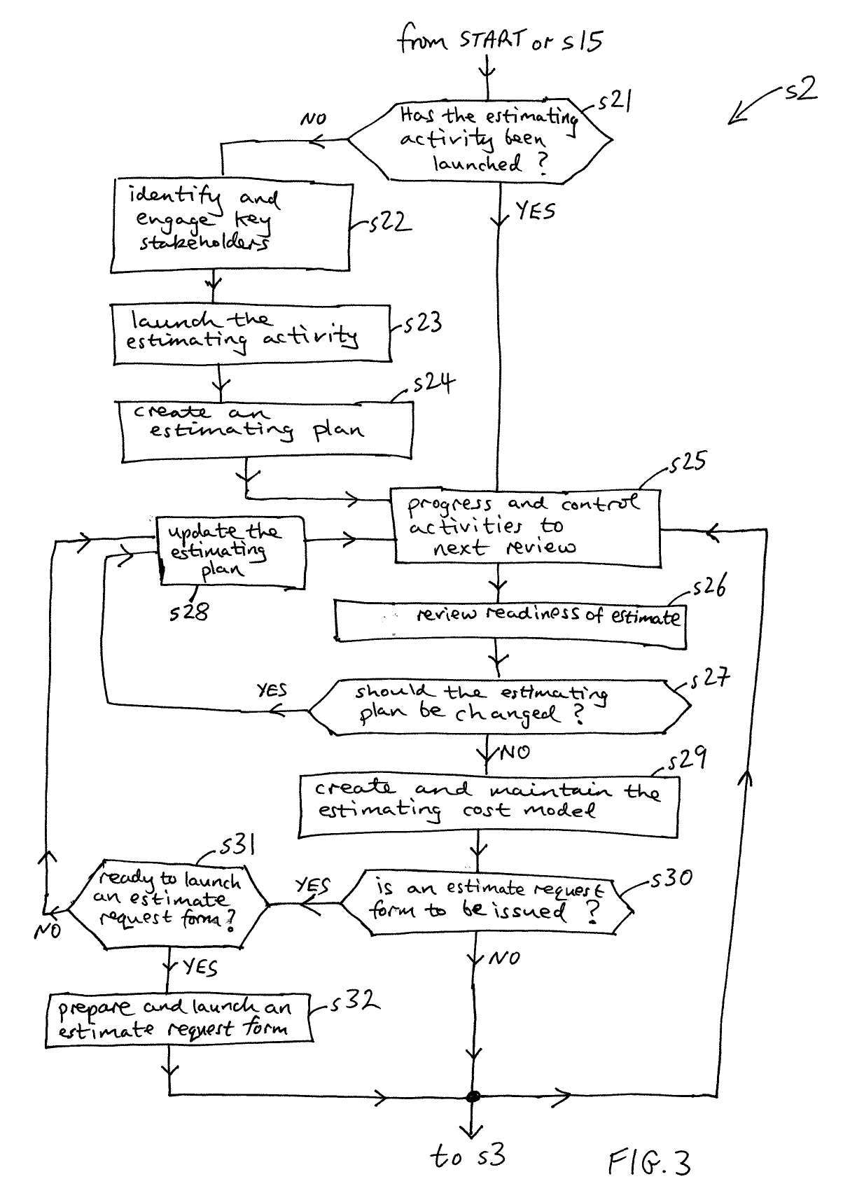

At step s2, the plan and manage module 100 performs planning and management of the estimate, as will be described in more detail below with reference to FIG. 3.

For all steps in the process of FIG. 2 (and as is also the case with each other step described below for all of the processes described below for all the above mentioned modules unless stated otherwise): input data may comprise operator input received via the operator input/output module 900; output data may comprise data output to operators via the operator input/output module 900; additionally or alternatively, data may be received from and/or output to one or more of the other modules of the estimating system 1, as appropriate; and performance of the step comprises processing and transforming data received as described in this paragraph and/or other data already held by the module.

At step s3, the decision module 150 determines whether one or more top down estimates are required.

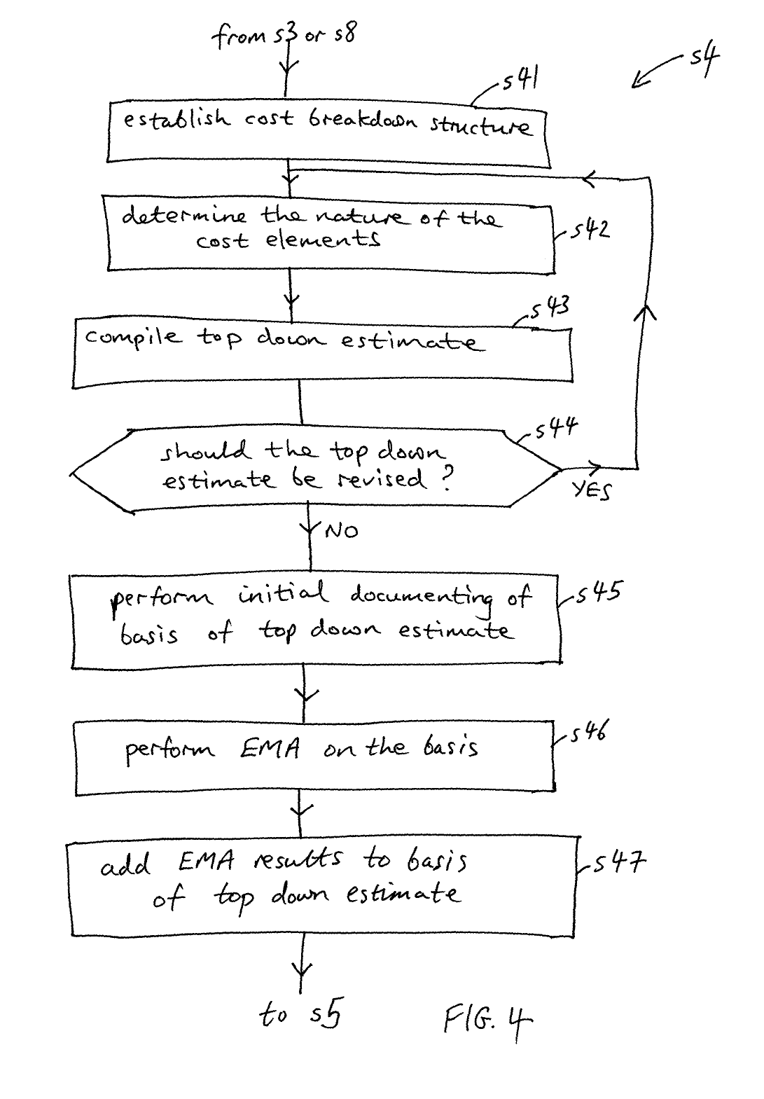

If the outcome of step s3 is that top down estimates are indeed required, then the process moves to step s4, where the top down module 200 creates and maintains top down estimates. The top down estimates may also be termed commercial independent estimates. Step s4 will be described in more detail below with reference to FIG. 4. The process then moves to step s5.

If on the other hand the outcome of step s3 is that top down estimates are not required, then the process moves directly from step s3 to step s5.

At step s5, the decision module 150 determines whether one or more bottom up estimates are required.

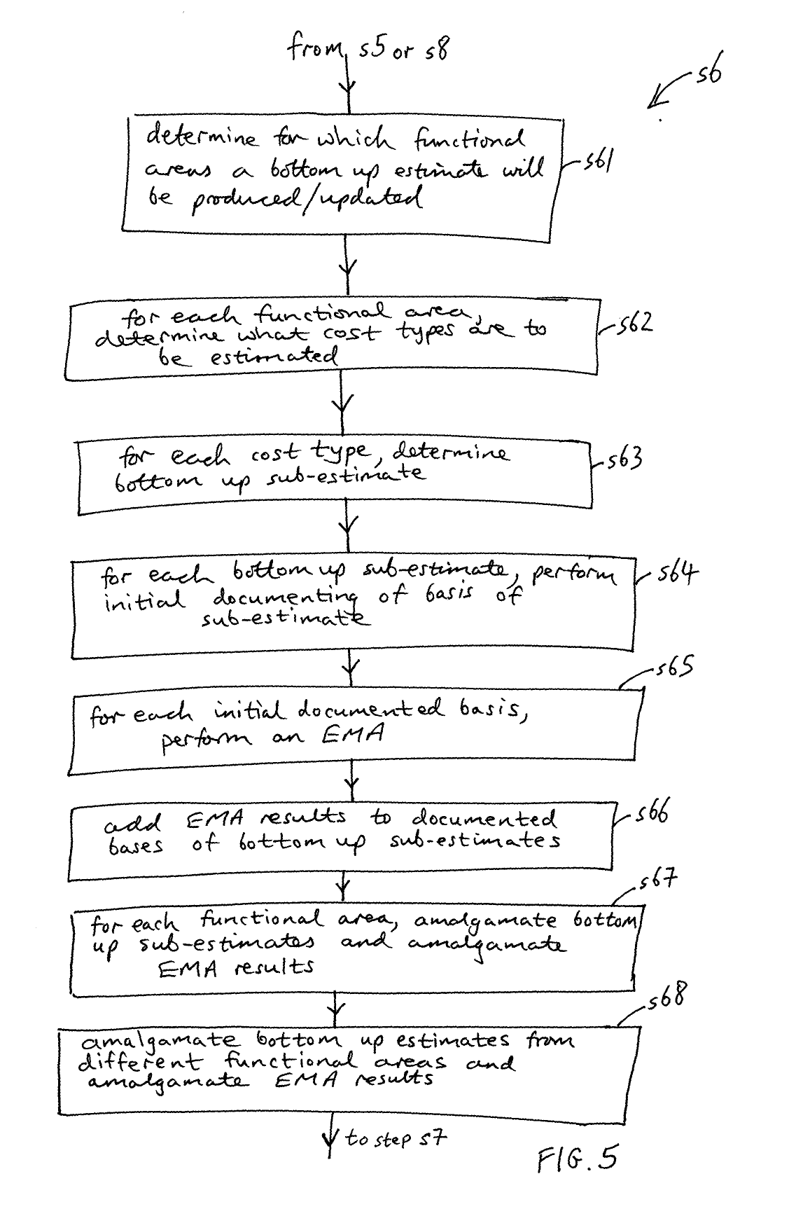

If the outcome of step s5 is that bottom up estimates are indeed required, then the process moves to step s6, where the bottom up module 300 creates and maintains bottom up estimates. The bottom up estimates may also be termed functional estimates. Step s6 will be described in more detail below with reference to FIG. 5. The process then moves to step s7.

If on the other hand the outcome of step s5 is that bottom up estimates are not required, then the process moves directly from step s5 to step s7.

At step s7, the validate or challenge module 400 validates or challenges one or more of the estimates produced in the above described steps i.e. analyses them and determines whether to classify them as valid or to challenge them as being in doubt either in part or in total. If it determines that challenging is required, this is performed. Step s7 will be described in more detail later below. The process then moves to step s8.

At step s8, the decision module 150 determines whether one or more of the top down estimates and/or one or more of the bottom up estimates require further processing before continuing with the main process flow. This determination will depend at least in part on whether the estimates were validated or challenged in step s7, and if challenged, the outcome of any challenge.

If the outcome of step s8 is that one or more of the top down estimates and/or one or more of the bottom up estimates indeed require further processing before continuing with the main process flow, then the process moves back, as appropriate, to step s4 for top down estimates and/or to step s6 for bottom up estimates.

If on the other hand the outcome of step s8 is that one or more of the top down estimates and/or one or more of the bottom up estimates do not require further processing before continuing with the main process flow, then the process moves from step s8 to step s9.

At step s9, the decision module 150 determines whether a risk, opportunity and uncertainty evaluation is to be performed at this stage in the process. (As will be described in more detail later below, the estimating process of FIG. 2 may be implemented in a feedback/iteration manner, and therefore for example it may be determined in some passes through the process to perform a risk, opportunity and uncertainty evaluation at this stage, but in other passes through the process it may be determined to not perform such an evaluation at this stage.) One requirement that needs to be satisfied for a risk, opportunity and uncertainty evaluation to be performed is that a current baseline estimate needs to have been provided in the previous steps, e.g. as part of the top down estimate or the bottom up estimate, or, say, respective baselines estimates from each of those.

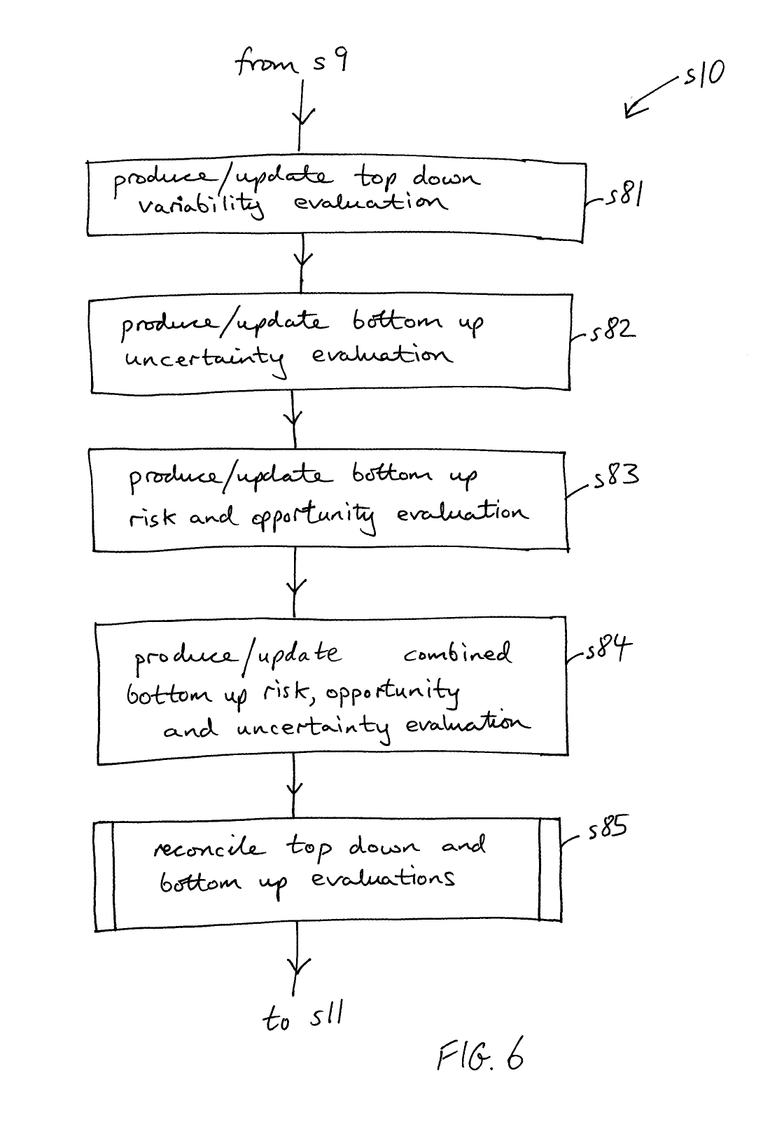

If the outcome of step s9 is that a risk, opportunity and uncertainty evaluation is indeed to be performed at this stage in the process, then the process moves to step s10, where the risk, opportunity and uncertainty module 500 compiles risk, opportunity and uncertainty evaluations. Step s10 will be described in more detail below with reference to FIG. 6. The process then moves to step s11.

If on the other hand the outcome of step s9 is that a risk, opportunity and uncertainty evaluation is not to be performed at this stage in the process, then the process moves directly from step s9 to step s11.

At step s11, the decision module 150 determines whether an estimate recommendation is to be compiled at this stage in the process, and/or whether to update any existing estimate recommendation. (As will be described in more detail later below, the estimating process of FIG. 2 may be implemented in a feedback/iteration manner, and therefore for example it may be determined in some passes through the process to update the estimate recommendation at this stage, but in other passes through the process it may be determined to not perform such an update at this stage.)

If the outcome of step s11 is that an estimate recommendation is indeed to be compiled or updated at this stage in the process, then the process moves to step s12, where the estimate recommendations module 600 performs such compilation or updating. Step s12 will be described in more detail below. The process then moves to step s13.

If on the other hand the outcome of step s11 is that an estimate recommendation is not to be compiled or updated at this stage in the process, then the process moves directly from step s11 to step s13.

At step s13, the decision module 150 determines whether estimate clearance is to be performed at this stage in the process. (As will be described in more detail later below, the estimating process of FIG. 2 may be implemented in a feedback/iteration manner, and therefore for example it may be determined in some passes through the process to perform estimate clearance at this stage, but in other passes through the process it may be determined to not perform such a clearance at this stage.)

If the outcome of step s13 is that an estimate clearance is indeed to be performed at this stage in the process, then the process moves to step s14, where the clearance module 700 performs such clearance. Step s14 will be described in more detail below. The process then moves to step s15.

If on the other hand the outcome of step s13 is that an estimate clearance is not to be performed at this stage in the process, then the process moves directly from step s13 to step s15.

At step s15, the decision module 150 determines whether any further work is required on the estimate. If the outcome of step s15 is that further work is indeed required, then the process returns to step s2.

If on the other hand the outcome of step s15 is that no further work is required, then the process ends. One reason for an outcome that no further work is required would be that the estimate has been finalised i.e. is completed. Another reason would be that the estimate has been suspended or abandoned i.e. is no longer required.

FIG. 3 is a process flowchart showing certain steps performed by the plan and manage module 100 in implementing the above mentioned process of step s2 of planning and managing the estimate process. In some embodiments, the decision module 150 may be made use of by the plan and manage module 100, in particular in implementing determination steps.

For all steps in the process of FIG. 3: input data may comprise operator input received via the operator input/output module 900; output data may comprise data output to operators via the operator input/output module 900; additionally or alternatively, data may be received from and/or output to one or more of the other modules of the estimating system 1, as appropriate; and performance of the step comprises processing and transforming data received as described in this paragraph and/or other data already held by the module.

At step s21, it is determined whether the estimating activity has been launched. Input data for this step may include evidence of ongoing estimate activities.

If the outcome of step s21 is that it is determined that estimating activity has not been launched, e.g. no Functional or Commercial estimating activity is ongoing and hence no corresponding data or evidence is present, then the process moves to step s22.

At step s22 key stakeholders are identified and engaged.

In conventional processes, estimating activity is typically launched by, for example, estimate request forms or the like. In contrast, in this embodiment, by virtue of steps s21 and s22, stakeholders can be engaged earlier, thereby making better use of the total time available and providing focus on the estimating activity and the information available from or required by the stakeholders.

The process then moves on to step s23 at which the estimating activity is launched.

The process then moves on to step s24 at which an estimating plan is created.

The estimating plan is provided by virtue of operator input data received via the operator input/output module 900. The operator input data may comprise, or be based upon, any appropriate factors, for example any one or more of the following in combination:
Data relating to the maturity of information available, the timescales available and the proposed contracting arrangements/price type to be offered.
Data relating to assessments of the Estimating Resource available, both Commercial and Functional.
Data specifying (as agreed) activities which stakeholders need to discharge in order to support and produce the Estimate.
Data forming a datum against which the Estimating activities can be reviewed and progressed.
Data specifying “Who is involved?”—e.g. identification of individuals i.e. operators who will perform Estimating Roles and Responsibilities against respective stages of the estimating process and act upon and input relevant data—this includes data specifying an Estimate Readiness Review Forum including membership i.e. operators, terms of reference, and so on.
Data specifying “What is being estimated and why?”—e.g. data specifying Key Requirements and Assumptions which outline the Estimating Baseline; e.g. data identifying Key Information in terms of specific documents which will form the Estimating Baseline, who will provide them, who needs them and when; and e.g. data derived from an assessment of the status and maturity of Key Information which thereby determines and defines how immaturity will be addressed in the estimate (e.g. through risk or uncertainty contingency or by qualification of the estimate).
Data specifying “How is the estimating going to be performed?”—e.g. data specifying the Estimating Strategy in terms of the type of estimate which will be produced and the timing of refreshes; e.g. data specifying the Scope of the Estimate in terms of the parts of the Work/Organisational or Cost breakdown structure and/or any options which will be estimated for; e.g. data specifying selected appropriate Estimating Methodologies appropriate to the maturity of the Key Information available, the Estimating Strategy and the estimating capabilities and resources available; and e.g. data specifying the appropriate use of particular discretionary elements of the estimating process.
Data specifying “When do actions need to be performed?”—e.g. data specifying schedules of activities and deliverables as agreed by Key stakeholders.

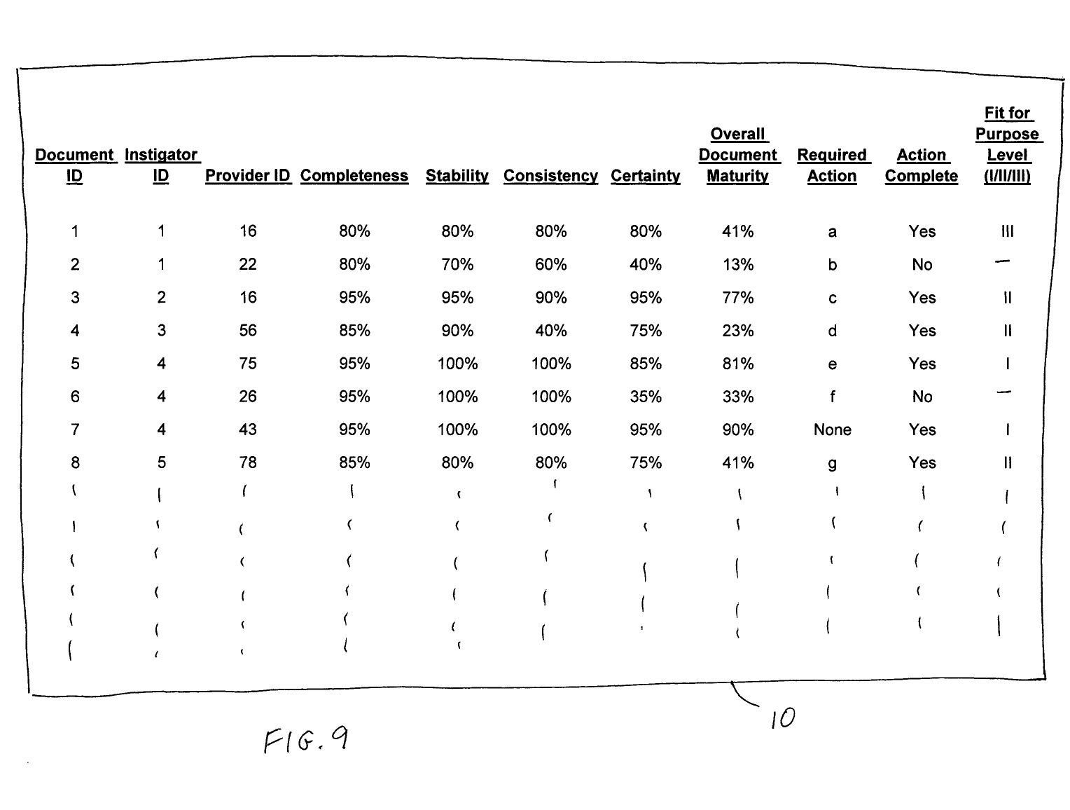

In this embodiment, the estimating plan includes a critical document register (which may also be referred to as a critical document maturity matrix). The critical document register will be described in more detail below with reference to FIG. 9. The process then moves on to step s25. The documents (whether physical or electronic), or potential documents to be created, or sets of information, which are contained in the critical document register are preferably those defining which elements of information which are considered preferable or essential to creating a robust estimate as agreed with the key stakeholders; in general they will relate to one of more categories of information as listed above.

If on the other hand the outcome of step s21 is that it is determined that estimating activity has been launched, then the process moves directly from step s21 to step s25.

At step s25, estimating activities are progressed and managed until a scheduled time is reached for a next readiness review of the estimate, at which time the process moves on to step s26.

At a first implementation of step s26, the estimate or estimating readiness is reviewed i.e. a determination of whether the organisation is ready to produce an estimate in terms of a numerical value and an associated basis of estimate (i.e. the context and rationale used to create the numerical value). In this embodiment, this comprises at least an assessment of the maturity level values provided by in the critical document register. Later passes through step s26 will repeat this until it is determined the estimate is ready to be produced. Thereafter, at further passes through step s26 required ongoing support for the estimate production is determined. In practice there will be some overlap or combination of these two main thrusts for step s26 at any given implementation of step s26. Thus, as a first approximation for step s26, when implementing an Estimate Readiness Review it is focussing on whether the organisation is ready to estimate, and when implementing an Estimate Progress Review it is focussing on the support required during the creation of the estimate once it has commenced

The step (or process) s26 of reviewing the estimate or estimating readiness may be implemented in any appropriate manner. In this embodiment this comprises an assessment of the status of the critical document register. Further details of this are given later below after the further details of the critical document register have been described. When a particular iteration of step s26 is completed, the process moves to step s27 at which it is determined (on the basis of the outcome of step s26) whether the estimating plan should be changed. If it is determined that the estimating plan should indeed be changed, then the process moves to step s28.

At step s28 the estimating plan is updated. This is implemented by adaptations, as appropriate, to the processes and outcomes that were initially implemented at the step s24 of creating the estimate plan.

Thus, for example, if at steps s25 and s26 the maturity of Key Information/documentation is found to be unacceptable for the Lifecycle phase the process is at or against the Target maturity set, the Estimating Plan needs to be reviewed. The estimating methodologies may now be inappropriate or the price type requested may be likely to expose the organisation producing the estimate to an unacceptable level of uncertainty or risk.

The process then returns to step s25.

If on the other hand the outcome of step s27 is that it is determined that the estimating plan does not need to be changed, then the process moves directly from step s27 to step s29.

At the first pass through step s29, an estimating cost model is created. At further passes through step s29, the estimating cost model is updated or otherwise maintained.

The cost model serves to compile the estimate as it evolves. Any appropriate software may be used, e.g. a spreadsheet, that allows build up of the cost estimate to be recorded and analysed at each key stage in the overall estimating process.

Preferably the following positions should be stored under configuration control:
A top down estimate, where no bottom up estimate is to be used
A Functional return, and a Reconciled Functional view, where different—see further details in the step s4 of creating top down estimates.
Risk, Uncertainty and Opportunity—see further details in the step S10 of compiling risk, opportunity and uncertainty evaluations.
Estimate Recommendations—see further details in the step s12 of compiling or updating the estimate recommendation.
Pricing allowances, such as Profit and other allowances, where a Price Recommendation is to be made—see further details in the step s12 of compiling or updating the estimate recommendation.
Each Estimate refresh—as scheduled in the Estimating Plan.
Options to be costed/priced—as detailed in the Estimating Plan.

The process then moves on to step s30.

At step s30, it is determined whether an Estimate Request Form is to be issued. In this context an estimate request form is a process-initiation document that is issued when the system is ready to produce the estimate, i.e. when the estimate or estimating readiness review process has completed, at least for any given sub-part of the estimate process. The estimate request form is issued to all relevant functionalities. Thus here, unless for any reason the estimate (at least for any given sub-part of the estimate) is to be postponed, amended or cancelled, the determination will be that an estimate request form is indeed to be issued. The estimate request form may be a first version thereof for any given sub-part of the estimate or the whole thereof, or may be an updated version of either of those.

In this embodiment the Estimate Request Form is the primary means of requesting the Functions to produce an estimate, it formalises the request and can be used for all or selected parts of Cost Breakdown Structure. It is used to request Functional estimates for Direct, Indirect, Investment or R&T resources and can also be used to gather other information from the Functions as required (for example information on key risks faced by the function, or information required to support the estimate creation e.g. a Bill of Material). The Estimate Request Form may also be called the Estimating Instructions or Ground Rules, particularly in the USA.

In this embodiment the Estimate Request Form (ERF) release dates, what the ERF will cover and which teams/functions need to respond to the ERF are determined as part of the step s24 of creating the Estimating Plan and/or the step s28 of updating the estimating plan. Estimate request form releases are preferably configuration controlled to ensure all key stakeholders are working to the correct Estimating Baseline.

If at step s30 it is determined that an estimate request form is indeed to be issued, then the process moves to step s31.

At step s31, it is determined whether the system/process is ready to launch an estimate request form, i.e. is the information that has been entered into the system determined as mature enough to allow an estimate request form to be launched.

In this embodiment the step s26 of reviewing the estimate or estimating readiness and the step s27 of determining whether the estimating plan should be changed will have determined whether the necessary Key Information supporting the Estimating Baseline is available and is appropriately mature enough for it to be appropriate to allow the estimating request form to be released. If it is determined that information is lacking or inconsistent, then the decision of step s31 is that the estimating plan needs to be revised accordingly, and appropriate actions to resolve the issues are determined. These are implemented by returning the process to step s28 to update the estimating plan.

If on the other hand the outcome of the determining step s31 is that the system is indeed ready to launch an estimate request form then the process moves to step s32.

At step s32, the estimate request form is produced and launched. Preferably the following features are contained in the estimate request form:
The estimate request form highlights the customer's requirement and details all supporting documentation to be used for estimate generation. The availability and suitability of the supporting documentation will have been confirmed in advance during the step s26 of reviewing the readiness of the estimate.
The estimate request form specifies stakeholders to submit resource requirements against a defined Work Breakdown Structure and/or Organisational Breakdown Structure.
The estimate request form highlights key Assumptions, Dependencies and Exclusions and identifies any key commercial and operational issues that need to be considered when preparing proposal responses.
Timescales for response are defined in the estimate request form and are in line with the schedule for the overall estimating process.
In some cases, the estimate request form can be used to request information in support of the estimating process and the estimate to be produced

After step s32, and also after a negative outcome to the determination step s30 (i.e. if at step s30 it is determined that an estimate request form is not to be issued), the process then moves to step s3 (described earlier with reference to FIG. 2) and also returns to step s25 in an ongoing iterative loop manner. In other words, the outcome of any given loop within the process of step s2 is passed on to the process step s3, and is also fed back within the process of step s2 to step s25 to initiate another ongoing sub-loop within the process of step s2.

Further details will now be described of step s4 in which the top down module 200 creates and maintains top down estimates. The top down estimates may also be termed commercial independent estimates.

Top down estimates are produced using data that first takes an overview, and then decides how much this needs to be broken down to be able to achieve an acceptably accurate estimate. The problem will be broken down into smaller constituent elements, and various estimating techniques may be used in combination on the broken down constituent elements. For example, the following three techniques may be used: analogy, parametric, and expert opinion/judgement. In other words, in this top down approach an overview of the entire cost estimate is formulated first. High level subsystems are then defined which capture significant product/service groups. Subsystems are defined in further detail to point where an appropriate costing technique can be applied. The cost model increases in detail and clarity through time.

In further detail for this embodiment, FIG. 4 is a process flowchart showing certain steps performed by the top down module 200 in implementing the above mentioned process of step s4 of creating and maintaining top down estimates. In some embodiments, the decision module 150 may be made use of by the top down module 200, in particular in implementing determination steps. For all steps in the process of FIG. 4: input data may comprise operator input received via the operator input/output module 900; output data may comprise data output to operators via the operator input/output module 900; additionally or alternatively, data may be received from and/or output to one or more of the other modules of the estimating system 1, as appropriate; and performance of the step comprises processing and transforming data received as described in this paragraph and/or other data already held by the module.

At step s41, the cost breakdown structure is established.

In this embodiment the cost breakdown structure is developed through the aggregation of cost elements. It is made to be compatible with any cost breakdown structure established and agreed in the estimating plan. For example, a cost breakdown for integrating a known payload with a known aircraft may include/be broken down into the respective costs of the payload and the aircraft, design activities, physical integration cost, ground test, flight test, and kit set manufacture.

At step s42, the nature of the cost elements is determined. For each cost element the most appropriate costing technique is determined and the data and analysis requirements needed to use the technique are identified. Examples of suitable basic techniques are Analogy, Parametric or Expert Judgement.

At step s43, the top down estimate is compiled. Once the relevant data is accumulated, the top down estimate is compiled, using one or more of the above mentioned techniques applied to respective cost elements.

At step s44, it is determined whether the compiled top down estimate should be revised. The purpose of this determination step is to ensure that if the top down cost estimate produced during the previous sub-process cannot be validated, then there is a need to identify additional information, review the analysis of the data available, or use different estimating techniques. If the top down estimate needs to be revised, the process returns to the step s42 of determining the nature of the cost elements. If the top down estimate does not need to be revised, the process moves on to step s45.

At step s45, initial documenting of the basis of the top down estimate is performed. So that, during ongoing and later use of the top down estimate value, it is readily ascertainable as to what data and bases the top down estimate was produced, the approach used to provide the top down estimate is documented and stored. Preferably the documented information includes a provenance for the data sources used, reference to the exercises that have been undertaken to influence cost elements as well as a scope of use for the final figure. The process then moves to step s46.

At step s46, an “estimate maturity assessment” (hereinafter referred to as an “EMA”) is performed on the documented basis of the top down estimate (in other embodiments this may be omitted). In overview, performing the EMA comprises assessing the basis of the estimate against a scale of criteria or categories of relative levels of maturity of estimate. Further details of the EMA used in this embodiment are described later below and shown in Table 4. In the present embodiment the EMA is performed on the overall top down estimate. However, as is the case for many possible implementations of EMAs, the EMA could additionally or alternatively be performed on sub-elements of the top down estimate, e.g. separately for the labour costs estimate and the material costs estimate, and likewise each of these may be sub-divided and an EMA performed on each such further sub-division of the top down estimate. The process then moves to step s47.

At step s47, the results of the EMA (or EMAs) are added to the documented basis of the top down estimate. (Note in other embodiments no EMA is performed, i.e. steps s46 and s47 are omitted).

The process then moves to step s5 (described earlier with reference to FIG. 2). In other words, the outcome of any given pass through the process of step s4 is passed on to the next pass through the process step s5.

Further details will now be described of step s6 in which the bottom up module 300 creates and maintains bottom up estimates. The bottom up estimates may also be termed functional estimates in that they will typically be provided by specific functions within an organisation which have detailed experience in the given functional area, e.g. project management, engineering, manufacturing, procurement, and so on.

In further detail for this embodiment, FIG. 5 is a process flowchart showing certain steps performed by the bottom up module 300 in implementing the above mentioned process of step s6 of creating and maintaining bottom up estimates. In some embodiments, the decision module 150 may be made use of by the bottom up module 300. For all steps in the process of FIG. 5: input data may comprise operator input received via the operator input/output module 900; output data may comprise data output to operators via the operator input/output module 900; additionally or alternatively, data may be received from and/or output to one or more of the other modules of the estimating system 1, as appropriate; and performance of the step comprises processing and transforming data received as described in this paragraph and/or other data already held by the module.

The bottom up estimate is preferably be based on key documentation agreed in the earlier described estimate readiness review stages of the earlier described plan and manage estimates process, and where appropriate as summarised in the earlier described estimate request form (and its output formatted in accordance with requirements specified in the estimate request form).

In a first pass through the overall process of step s6 the actions to be described below are carried out for a first time, i.e. the relevant item or activity is created for a first time. On subsequent passes through the overall process of step s6 the actions to be described below are carried out in an updating or refining manner, i.e. updating or refining the previous version of any given item or activity. In some passes through the overall process of step s6 where generally speaking updating is taking place, nevertheless for a new functional area or new sub-part of any process there may be creating steps taking place.

At step s61, it is determined for which functional areas (e.g. project management, engineering, manufacturing, procurement, and so on) a respective bottom up estimate will be produced or updated.

At step s62, for each functional area, it is determined what cost types are to be estimated (e.g. in-house man-hours, other direct costs, indirect costs, material costs, investments costs, and so on).

At step s63, for each cost type, a bottom up sub-estimate is determined.

At step s64, for each bottom up sub-estimate, an initial (i.e. pre-EMA) documenting of the basis of the sub-estimate is performed.

At step s65, for each initial documented basis of the respective sub-estimate, an EMA is performed.

As described earlier, performing the EMA comprises assessing the basis of the estimate (or sub-estimate) against a scale of criteria or categories of relative levels of maturity of estimate. As mentioned earlier, further details of the EMA used in this embodiment are described later below and shown in Table 4.

At step s66, the respective EMA results are added to the respective documented bases of the top down sub-estimates.

At step s67, for each functional area, the different sub-estimates are amalgamated, and similarly the different corresponding EMA results are amalgamated, to produce, for each functional area, a respective estimate and associated EMA result.

At step s68, the estimates from the different functional areas are amalgamated, and similarly the different corresponding EMA results are amalgamated. By virtue of these actions, an overall bottom-up estimate value (for this pass through step s6) is produced or updated, and similarly an overall EMA result (for this pass through step s6) is produced or updated.

The process then moves to step s7 (mentioned earlier with reference to FIG. 2). In other words, the outcome of any given pass through the process of step s6 is passed on to the next pass through the process step s7.

As just described, in the present embodiment an EMA is performed separately on each bottom up sub-estimate (and amalgamated later). However, in other embodiments an EMA could alternatively be performed only after sub-elements have been amalgamated for each functional area, or even, in yet further embodiments, after estimates from different functionalities have been amalgamated.

In yet further embodiments no EMA is performed as part of creating and maintaining bottom up estimates, i.e. steps s65 and s66 may be omitted, and steps 67 and s68 simplified accordingly.

Further details will now be described of the step s7 in which the validate or challenge module 400 validates or challenges one or more of the estimates produced in the above described steps i.e. analyses them and determines whether to classify them as valid or to challenge them as being in doubt. If it determines that challenging is required, this is performed. As part of implementation of step s7: input data may comprise operator input received via the operator input/output module 900; output data may comprise data output to operators via the operator input/output module 900; additionally or alternatively, data may be received from and/or output to one or more of the other modules of the estimating system 1, as appropriate; and performance of the step comprises processing and transforming data received as described in this paragraph and/or other data already held by the module.

The validating and challenging is performed on the basis of data and questions provided by one or more operators who are different to any operators whose input data was used to provide the bottom up estimates or top down estimates, although both parties may be used to validate or challenge the other. The relevant bottom up estimate data is reviewed in terms of various aspects, and this is done in a two-way basis between the operators who controlled implementation of the bottom up estimates and the operators performing the validating and challenging. Preferably, the aspects to be covered include the following:
Review of the Basis of Estimate (Assumptions, Exclusions, Qualifications and associated Documentation).
Review of Areas and Range of Uncertainty.
Review of the Risks and Opportunities included in the Bottom Up (Functional) Estimate.
Review of the Risks and Opportunities excluded from the Bottom Up (Functional) Estimate.

Alternatively, the relevant top down estimate data may be reviewed in terms of various aspects, and this is done in a two-way basis between the operators who controlled implementation of the top down estimates and the operators performing the validating and challenging. Preferably, the aspects to be covered include the following:
Review of the Basis of Estimate (Assumptions, Exclusions, Qualifications and associated Documentation).
Review of Areas and Range of Variability.
Review of the Risks and Opportunities inherent in the Top down Estimate (i.e. implied through the comparative data and technique employed).
Review of the Risks and Opportunities excluded from the Top down Estimate.

When an aspect has been reviewed, it is determined whether the independent operator is prepared to validate the data that has been reviewed, i.e. agrees it is acceptable to go forward. If not, then the data is in effect challenged, and details of the challenge are input to be acted upon in later passes through the overall process as appropriate.

In some embodiments, an independent EMA may be performed, i.e. with grading of the levels being determined according to the assessment of the independent operator(s) performing the independent validating/challenging. Such an independent EMA may be performed irrespective of whether an EMA has been performed as part of the bottom up estimating process of step s6.

Further details will now be described of step s10 in which the risk, opportunity and uncertainty module 500 compiles risk, opportunity and uncertainty evaluations.

Risk, opportunity and uncertainty evaluations may be performed on either or both the current top down estimate results and the current bottom up estimate results, in particular in relation to their respective baseline estimates. In this embodiment, evaluations are performed on both top down and bottom up, and moreover these evaluations are then reconciled with each other.

An uncertainty relates to an element or variable which will occur or be required, but the exact parameter or value is unknown. A risk is something that may or may not occur, but should it occur, is detrimental in some manner. An opportunity is something that may or may not occur, but should it occur, is beneficial in some manner. Should a risk or an opportunity occur then there will be an uncertainty around the exact outcome.

In further detail for this embodiment, FIG. 6 is a process flowchart showing certain steps performed by the risk, opportunity and uncertainty module 500 in implementing the above mentioned process of step s10 of compiles risk, opportunity and uncertainty evaluations. In some embodiments, the decision module 150 may be made use of by the risk, opportunity and uncertainty module 500, in particular in implementing determination steps. For all steps in the process of FIG. 6: input data may comprise operator input received via the operator input/output module 900; output data may comprise data output to operators via the operator input/output module 900; additionally or alternatively, data may be received from and/or output to one or more of the other modules of the estimating system 1, as appropriate; and performance of the step comprises processing and transforming data received as described in this paragraph and/or other data already held by the module.

In a first pass through the overall process of step s10 the actions to be described below are carried out for a first time, i.e. the relevant item or activity is created for a first time. On subsequent passes through the overall process of step s10 the actions to be described below are carried out in an updating or refining manner, i.e. updating or refining the previous version of any given item or activity. In some passes through the overall process of step s10 where generally speaking updating is taking place, nevertheless for a new functional area or new sub-part of any process there may be creating steps taking place.

At step s81, a top down variability evaluation is produced (or updated on subsequent passes through step s10). This is an evaluation of the variability of the current top down estimate results (as provided by step s4), in particular in relation to the current baseline estimate. Any appropriate evaluation technique may be used. Preferably, what is addressed includes contingency for items that have no specific definition, i.e. so-called “unknown unknowns” as these in particular should not be addressed in the bottom up estimates. The contingency should be a calculated value based on stretched or pessimistic values rather than an unvalidated factor or add-on.

In this embodiment, step s81 is performed by following an iterative approach to a top down variability checklist covering generic concerns and the use of schedule risk analysis (SRA) to drive the estimate value. This may be summarised as follows:
Apply generic uplift factors derived from stretched or pessimistic values e.g. inflationary factors or foreign exchange rates.
When possible calculate the schedule risk/uncertainty duration.
Apply a cost penalty related to schedule duration analysis.
Revise the generic uplift factor to cover activities which are not adequately scoped by the schedule penalty.

In particular in this embodiment the top down variability evaluation is based on an SRA. When appropriate or desired, confidence levels for the SRA may be captured using a Monte Carlo toolset.

In preparation for the reconciling of this top down evaluation outcome with the bottom up evaluation (which will be described below), a single value for the baseline estimate is chosen and the corresponding confidence level provided by this step s81 of evaluating the top down variability is determined.

For example, (these values will be used later below, merely by way of a hypothetical example as part of describing the reconciling process) an estimate amount of, say, £31.5 million, is chosen, and the corresponding SRA confidence level is determined for that amount, giving in this hypothetical example a SRA value of 80%. Equally possible is to determine these the opposite war round, i.e. to select a desired SRA confidence level of, say, 80%, and ascertaining the top down estimate value that is given at this certainty level.

At step s82, a bottom up uncertainty evaluation is produced (or updated on subsequent passes through step s10). This is an evaluation of the uncertainty of the current bottom up estimate results (as provided by step s6), in particular in relation to the current baseline estimate.

Any appropriate technique for evaluating uncertainty may be used. For example, assessment of various salient factors can provide a determination of three variations of the baseline estimate, termed respectively “Optimistic”, “Realistic”, and “Pessimistic”, each of which is derived from its own statistical distribution. It is not appropriate to simply average these three values. Rather, a combined evaluation based on the three distributions is more appropriate. In this embodiment, Monte Carlo models/tools are used to combine three such distributions to arrive at an overall uncertainty evaluation/value. Such techniques are well known to the skilled person. Further details for this particular embodiment are as follows.

A basic source of the uncertainty evaluation is preferably a cost breakdown structure (or cost element structure) previously employed in the estimating process, leading to a selection of cost elements to be analysed. Certain relevant data should be available in the earlier produced bases of the estimate bottom up.

In this embodiment, the following properties are determined for each selected cost element:
“Optimistic cost”—the lowest cost which can reasonably be expected, not necessarily the minimum value.
“Pessimistic cost”—the high cost which can reasonably be expected, not necessarily the maximum value.
“Baseline cost”—the most likely cost, typically will be the baseline estimate that has been produced.
Distribution—a distribution appropriate to the quality of data being used is selected.

Values of these properties are then determined for each selected cost element. These outcomes are then modelled together, using a Monte Carlo simulation, to generate a range of values associated with the overall estimate value. In this embodiment, a regular shape is assumed for the output distribution, which is typically considered to be a reasonable approach when modelling uncertainty. The range of values (where the values themselves are for a hypothetical example not linked to previously mentioned hypothetical examples) may be of a form such as represented in the following Table 1:

TABLE 1

| | | Baseline/ | | Spread |
|---|---|---|---|---|
| | Optimistic | Realistic | Pessimistic | Between 10% |
| | 10% Con- | 50% Con- | 90% Con- | and 90% Con- |
| Summary | fidence | fidence | fidence | fidence |
| position: | Level | Level | Level | Level |
| Cost (£ | 26.1 | 27.8 | 29.6. | 13.5% |
| Million) | | | | |

At step s83, a bottom up risk and opportunity evaluation is produced (or updated on subsequent passes through step s10). This is an evaluation of the risk and opportunity of the current bottom up estimate results (as provided by step s6), in particular in relation to the current baseline estimate.

Any appropriate technique for evaluating risk and opportunity may be used. Further details for this particular embodiment are as follows.

Specific risks and opportunities are identified. These should not be the same as the uncertainties considered in the previous step.

Certain properties are then determined for each identified risk or opportunity. In this embodiment, the following properties are determined:
“Optimistic cost”—the lowest cost which can reasonably be expected should the risk or opportunity occur.
“Pessimistic cost”—the cost resulting if the risk or opportunity occurs to its maximum reasonable extent.
“Realistic cost”—the cost resulting if the risk or opportunity occurs to its most likely extent.
“Discrete impacts”—in the case where there are a specific number of discrete impacts, each should be costed separately to define an appropriate distribution.
“Probability of occurrence”—the probability that the risk or opportunity will materialise.
Distribution—a distribution appropriate to the quality of data being used is selected.

Values of these properties are then determined for each identified risk or opportunity. These outcomes are then modelled together, using a Monte Carlo simulation, to generate a range of values associated with the overall estimate value. In this embodiment, a difference for the risk and opportunity Monte Carlo modelling compared to the earlier described Monte Carlo modelling for the uncertainty is that for risk and opportunity the modelling is performed so as to include simulation of whether or not a risk or opportunity will occur in addition to the cost impact should it indeed occur. Due in part to this, it is no longer reasonable to expect a regular shape to the output distribution. The range of values (where the values themselves are for a hypothetical example not linked to previously mentioned hypothetical examples) may be of a form such as represented in the following Table 2:

TABLE 2

| | | Baseline/ | | Spread |
|---|---|---|---|---|
| | Optimistic | Realistic | Pessimistic | Between 10% |
| | 10% Con- | 50% Con- | 90% Con- | and 90% Con- |
| Summary | fidence | fidence | fidence | fidence |
| position: | Level | Level | Level | Level |
| Cost (£ | 0.071 | 0.643 | 2.384. | 336% |
| Million) | | | | |

At step s84, a combined bottom up risk, opportunity and uncertainty evaluation is produced (or updated on subsequent passes through step s10). Any appropriate technique providing this combined evaluation may be used. For example, the two separate results provided above in steps s82 and s83 may simply be averaged or the like. However, preferably, and as implemented in this embodiment, the combined bottom up risk, opportunity and uncertainty evaluation is produced (or updated on subsequent passes through step s10) by performing a joint Monte Carlo modelling on all the selected properties i.e. the selected risk and opportunity properties and the selected uncertainty properties, to generate a range of values associated with the overall estimate value. (Of course, it is therefore the case that in this embodiment the individual results provided above in steps s82 and s83 are not needed for producing the combined result. However, they may still serve various purposes, as will be discussed later below.) In this embodiment, the properties/variables analysed in this combined approach are the same as those described for the separate processes of steps s82 and s83. The range of values (where the values themselves are for a hypothetical example not linked to previously mentioned hypothetical examples) may be of a form such as represented in the following Table 3:

TABLE 3

| | | Baseline/ | | Spread |
|---|---|---|---|---|
| | Optimistic | Realistic | Pessimistic | Between 10% |
| | 10% Con- | 50% Con- | 90% Con- | and 90% Con- |
| Summary | fidence | fidence | fidence | fidence |
| position: | Level | Level | Level | Level |
| Cost (£ | 26.6 | 28.7 | 31.1 | 17% |
| Million) | | | | |

At step s85, the top down evaluation is reconciled with the bottom up evaluation (or such reconcile outcome is updated on subsequent passes through step s10). This may be performed for any of the above described bottom up evaluations (i.e. as produced at step s82 and/or s83 and/or s84). In this embodiment reconciling is performed only on the combined bottom up risk, opportunity and uncertainty evaluation that was produced (or updated on subsequent passes through step s10) at step s84.

Before step s85 is described in more detail, the following observations are made to aid understanding of benefits that may be derived from performing step s85.

The key strengths of top down assessments are:
Evaluates an overall view of risk, opportunity and uncertainty exposure within a single assessment
No need for specific and detailed knowledge on all identified sources of risk
Does not require a full understanding of the documentation suite
Has some scope to deal with unknown risks
Generally quick to apply

The key weaknesses of Top-down assessment are:
Limited functional buy-in
Relies significantly on Expert Judgement which is difficult to substantiate.

The key strength of Bottom-up assessments are:
Uses the detail available to inform the assessment
Functional buy-in to the assessment
Techniques used supported by statistical theory

The key weaknesses of Bottom-up assessments are:
Inability to assess contingency for items that have no specific definition
The consequential impacts of risk and uncertainty can be poorly understood
Integration risks are often difficult to assess
Duplication of impacts is possible
Relies on accurate assessments of probability of occurrence and correlation which are difficult to justify
Can be time consuming to compile the analysis
Require mature documentation suite to support the evaluation

Step s85 in effect harmonises the top down estimate and the bottom up estimate in a manner that tends to add, at least to an extent, the advantages of each whilst also tending to remove, at least to an extent, the disadvantages of each. This is in contrast to what might otherwise occur with other harmonising approaches in which the advantages might add but at the same time the disadvantages would also add/magnify. Step s85 achieves this by reconciling the above described evaluation outcomes for bottom up and top down, rather than reconciling the estimates as such i.e. “derivatives” of the top down and bottom up estimates are reconciled (namely the above evaluations) rather than the top down and bottom up estimates themselves.

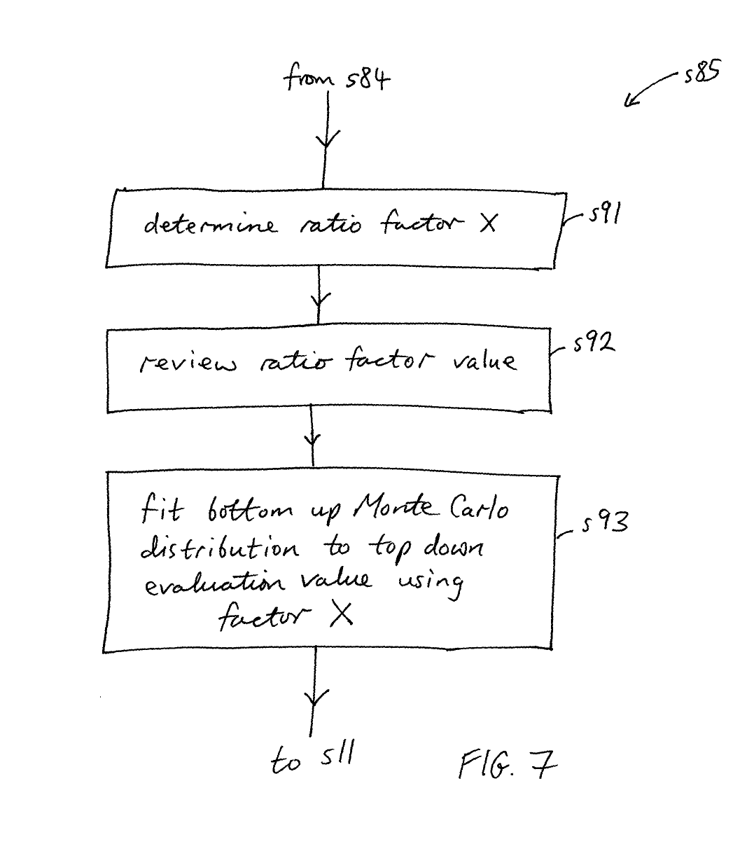

Step s85 as performed by the risk, opportunity and uncertainty module 500 in this embodiment will now be described in more detail with reference to FIG. 7. FIG. 7 is a process flowchart showing certain steps performed in implementing the reconciling process of step s85. For all steps in the process of FIG. 7: input data may comprise operator input received via the operator input/output module 900; output data may comprise data output to operators via the operator input/output module 900; additionally or alternatively, data may be received from and/or output to one or more of the other modules of the estimating system 1, as appropriate; and performance of the step comprises processing and transforming data received as described in this paragraph and/or other data already held by the module.

At step s91, a ratio factor is determined. The ratio factor (called, say, X) is indicative of a ratio of a measure of top down variability to a measure of bottom up variability (i.e. here, the bottom up risk, opportunity and uncertainty evaluation). See below for more details of how the factor X is determined.

At step s92, the determined ratio factor X is reviewed. This is an optional step that is not required for performing the reconciliation. Nevertheless, in this embodiment this step is performed as a form of pre-filtering or “sanity check”, before going ahead with further steps of the reconciling process. In particular, due to the nature of the factor X in this embodiment, the next stage of the reconciling is only moved on to if the value of X is greater than or equal to 1, but not significantly greater than 1 (e.g. not greater than a value of 1.25, say i.e. 25% greater). This is because, in this embodiment, a value of X significantly greater than 1 (i.e. here greater than 1.25) suggests the top down variability evaluation may have been too pessimistic, and/or the bottom up variability evaluation (i.e. the bottom up risk, opportunity and uncertainty evaluation) does not adequately reflect the perceived levels of risk. This is also because, in this embodiment, a value of X less than 1 indicates the top down variability evaluation may be significantly overly optimistic, and/or the bottom up evaluation is based on significantly false premises or calculations. In contrast, a value greater than 1 but not too much greater than 1 (e.g. between 1 and 1.25) suggests there has been a good understanding of detailed risk and that variations between the top down variability evaluation and the bottom up evaluation is derived from expected and understandable differences. This also reflects the basic premise that the bottom up approach is inherently optimistic as it excludes any allowance for unknown risks whereas the top down approach by nature considers pessimistic stretched values. In other embodiments, other levels for the value deemed to be too much greater than 1 will be chosen, according to the needs of the operators of the estimating process, or other applicable or selected specific characteristics.

In further embodiments, a further option is, if step s92 provides a reject value for the factor X (e.g. here less than 1 or greater than 1.25), then an EMA is performed on some or all of the data used in the respective variability evaluations, and the one with the better EMA outcome is trusted more than the other one.

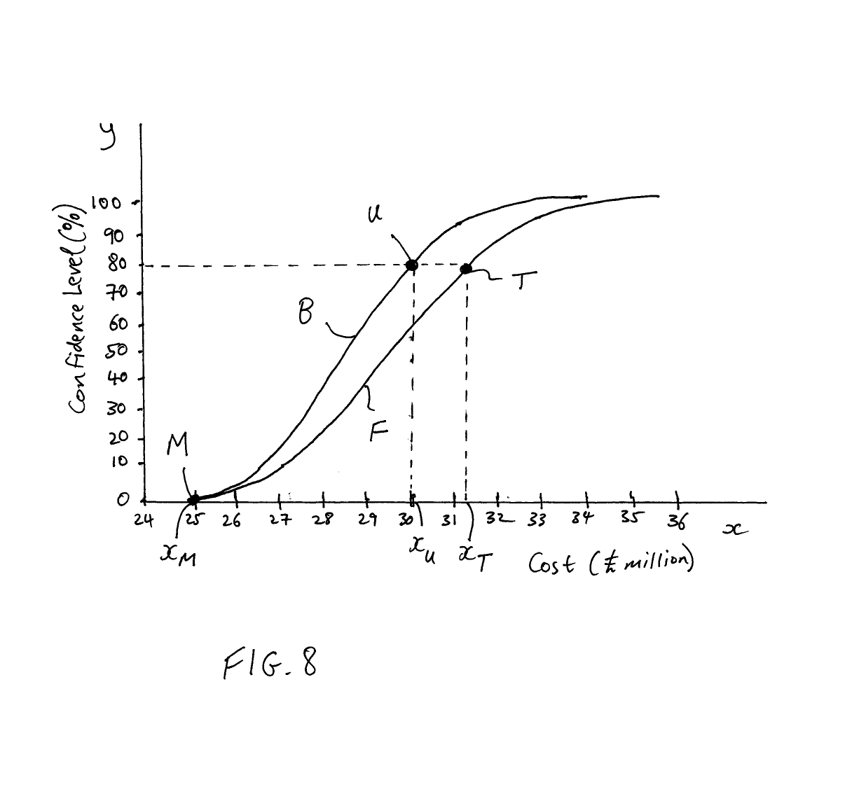

Moving on now to step s93, at step s93 the result for the distribution used to determine the bottom up evaluation, i.e. here the Monte Carlo distribution, is fitted (this may alternatively be termed normalised, or stretched) to the result value provided by the top down evaluation process. This fitting/normalising/stretching (hereinafter referred to as “fitting”) is performed using the value of the factor X, as will now be described in more detail with reference to FIG. 8.

FIG. 8 is a schematic (not to scale) representation of a hypothetical example of the fitting of a cumulative probability density function of the Monte Carlo output from the bottom up evaluation of risk, opportunity and uncertainty (i.e. this corresponds to the confidence level when considering the top down estimate) to a value (of confidence level) from the top down variability evaluation. Accordingly, the “y-axis” is cumulative probability (expressed as percentage) and the “x-axis” is estimate value (in e.g. millions of pounds, say). The plot/curve/distribution (hereinafter referred to as plot) of the cumulative probability density function of the Monte Carlo output from the bottom up evaluation versus estimated cost is indicated by reference sign B.

Whereas, as described in the preceding paragraph, cumulative probability is treated for the evaluation of the risk, opportunity and uncertainty of the bottom up estimate, the equivalent parameter derived/used in the above described variability evaluation of the top down estimate is the confidence level (expressed as percentage).

In this hypothetical example, the confidence level value chosen from the top down evaluation is equal to 80%. In this hypothetical example, a value for the top down estimate at that confidence level would have been determined at step s81. Let us say in this hypothetical example that value was 31.5 million pounds. This is therefore represented in FIG. 8 as the point corresponding to a y-axis value of 31.5 million pounds and an x-axis value of 80%. This point is marked in the Figure and is indicated by reference sign T (and hereinafter for convenience is referred to as point T). Thus, in other words, point T is in effect the (chosen) top down evaluation result. In FIG. 8, the point on the plot B with the chosen confidence level (i.e. the same value of confidence level as the confidence level chosen from the top down evaluation, being in this example 80%) is indicated by reference sign U. In FIG. 8, the point in the plot B where the confidence level (i.e. the y-axis value) first (in the sense of moving back down the curve from point U) equals zero is indicated by reference sign M.

Then, the plot of the cumulative probability density function of the Monte Carlo output from the bottom up evaluation is fitted to the top down evaluation result, i.e. is fitted to the point T.

In this embodiment, fitting of the plot of the cumulative probability density function of the Monte Carlo output from the bottom up evaluation to the point T is performed as follows:

(i) it is defined that the fitted plot will pass through the point T;

(ii) the factor X is determined; and

(iii) the new values for the remainder of the fitted version of the plot are calculated using the factor X.

In FIG. 8, the fitted version of the plot is indicated by the reference sign F.

Thus the distribution information within the original plot B (i.e. the evaluation of the risk, opportunity and uncertainty of the bottom up estimate) has been retained, but it has been reconciled with the top down variability evaluation result. The reconciled plot is output to step s11 (described earlier with reference to FIG. 2) as the only output, or as one of plural outputs, from step s10.

Further details of the factor X of this embodiment will now be described.

We define the point/value on the x-axis for the above described point T as x_{T}.

We define the point/value on the x-axis for the above described point U as x_{U}.

We define the point/value on the x-axis for the above described point M as x_{M}.

Then the factor X is defined as:

X=(x_{T}−x_{M})/(x_{U}−x_{M})

How the new values for the remainder of the fitted version F of the plot are calculated using the factor X in this embodiment will now be described.

We define that any given point on plot B with a given confidence level (i.e. y-axis value) y_{B} has a corresponding point/value on the x-axis of x_{B}. Then, on plot F, for the same value of y (i.e. for y_{F}=y_{B}) the corresponding point on plot F will have a point/value on the x-axis of x_{f}, where:

X_{F}=[(x_{B}−x_{M})·X]−x_{M}

Further details will now be described of step s12 in which the reconcile and maintain module 600 reconciles and maintains estimate recommendations. In some embodiments, the decision module 150 may be made use of by the reconcile and maintain module 600, in particular in implementing determination steps. Input data may comprise operator input received via the operator input/output module 900, and output data may comprise data output to operators via the operator input/output module 900. Additionally or alternatively, data may be received from and/or output to one or more of the other modules 100-500 and 700 of the estimating system 1, as appropriate.

In a first pass through the overall process of step s12 the actions to be described below are carried out for a first time, i.e. the relevant item or activity is created for a first time. On subsequent passes through the overall process of step s12 the actions to be described below are carried out in an updating or refining manner, i.e. updating or refining the previous version of any given item or activity. In some passes through the overall process of step s12 where generally speaking updating is taking place, nevertheless for a new functional area or new sub-part of any process there may be creating steps taking place.

In this step, in effect the various elements carried out so far are “pulled together”. Estimate recommendations provide summaries and other forms of the status of the estimate and associated information. For example, estimate recommendations may identify how the cost may be broken down into baseline cost, uncertainty allowance and risk/opportunity, allowing an overall view of contingency to be generated.

In this embodiment, the status of estimate inputs is validated and estimate recommendations are consolidated.

This acts as a checking function to ensure that the information required to complete Cost Estimate Recommendations is in place. It acts as a roll up and consolidation process to bring together the inputs needed to complete the process such as the top down (Commercial Independent) Estimate, the bottom up (Authorised Functional) Estimates and the Risk, Opportunity and Uncertainty Evaluations, and the maturity of the information available.

If a previous Estimate Recommendation has been made, changes introduced in the new recommendation are identified and adequate audit trails verified.

Data relating to external issues may be analysed, processed or otherwise incorporated.

Routine cost rates may be reviewed e.g. standard hourly rates may have increased since a previous version or iteration of the estimating process was performed.

The resulting Cost Estimate Recommendations are documented and stored under a Configuration Control regime. The qualifications and limitations of the estimate data should preferably be highlighted as this will aid the next steps, in particular the step s14 of estimate clearance. The Cost Estimate Recommendations are also fed into the Defined Cost Model produced in the step s2 of planning and managing the estimate, allowing the estimate to be tracked to final price agreement.

Further details will now be described of step s14 in which the clearance module 700 performs estimate clearance. In some embodiments, the decision module 150 may be made use of by the clearance module 700, in particular in implementing determination steps. Input data may comprise operator input received via the operator input/output module 900, and output data may comprise data output to operators via the operator input/output module 900. Additionally or alternatively, data may be received from and/or output to one or more of the other modules 100-600 of the estimating system 1, as appropriate.

In a first pass through the overall process of step s14 the actions to be described below are carried out for a first time, i.e. the relevant item or activity is created for a first time. On subsequent passes through the overall process of step s14 the actions to be described below are carried out in an updating or refining manner, i.e. updating or refining the previous version of any given item or activity. In some passes through the overall process of step s14 where generally speaking updating is taking place, nevertheless for a new functional area or new sub-part of any process there may be creating steps taking place.

In step s14, clearance of the estimate, or its current state, is provided by one or more operators of the organisation, making use of the data available from the process to do date as required.

FIG. 9 is a schematic and simplified representation of the earlier mentioned critical document register, which will now be described in more detail.

In this embodiment, the critical document register 10 is produced as part of the estimating plan. The critical document register 10 stores a matrix comprising various entries for each “document” that is required by an operator or module to discharge the role of that operator or module. Some entries may be common to more than one operator/module, some may be unique to an individual operator/module. The term “document” encompasses paper or electronic records of items such as lists, schedules, process flowcharts, calculations, determinations, and so on. These may include data related to programmatic matters such as schedules, quantities, timescales etc., and/or data related to the physical product such as bill of materials, statement of work, test specifications etc., and/or commercial information, and/or customer information. Thus, as shown in the simplified form of the critical document register 10 of FIG. 9, for each document there is an entry that is the unique identifier (“Document ID”) of the respective document.

Any such document is deemed by the instigating operator/module as being required i.e. “critical” for the estimate creation. Thus, as shown in the simplified form of the critical document register 10 of FIG. 9, for each document, a further entry is the unique identifier (“Instigator ID”) of the instigating/requesting operator/module.

The critical document register 10 further stores the identity of the operator/module responsible for providing the document. Thus, as shown in the simplified form of the critical document register 10 of FIG. 9, for each document, a further entry is the unique identifier (“Provider ID”) of the providing operator/module.

The providing operator/module performs a document maturity assessment process, to determine a measure of the maturity of the document.

In this embodiment, the document maturity assessment process is as follows. Four maturity parameters are determined or estimated. A first one is completeness. A second one is stability e.g. absence of known change. A third one is consistency e.g. determined by assessing integration of different paths of the process. A fourth one is certainty i.e. an assessment of how certain it is that the data to be used in the estimate process is not going to change. Each of these are given a value on an appropriate value scale, e.g. as a percentage (which may be rounded), or as a qualitative assessment such as High/Medium/Low which is then interpreted against a nominal percentage scale. The overall maturity assessment measure is then the value obtained by multiplying the four individual values together. For example, if each of the four categories of completeness, stability, consistency and certainty had an individual percentage value of 80%, then the overall maturity assessment value would be 80%×80%×80%×80%=40.96% (i.e. ≈41%).

Thus, as shown in the simplified form of the critical document register 10 of FIG. 9, for each document, further entries are the values of each of the four individual document maturity assessment parameters (“Completeness”, “Stability”, “Consistency”) and the resulting overall document maturity assessment value (“Overall Document Maturity”).

Optional ways in which undesirable low levels of document maturity may be responded to include the following. Stakeholders may agree to peg an assumption for the purposes of estimating (i.e. take it as being true). In addition this may suggest that allowance is made in terms of the uncertainty range around the input values linked to those assumptions, or the raising of a risk or opportunity to reflect that the something different may or may not occur. In some cases it may be appropriate to exclude cases where the assumption is later shown to be false (putting the alternative out of scope). Such approaches, or actions, are included as further entries (“Required Action”) in the simplified form of the critical document register 10 of FIG. 9.

As will be described shortly below, a further entry will be a fit for purpose level. This level is, however, not determined until any actions required to address low document maturity, as mentioned in the preceding paragraph, have been carried out. Accordingly, a further entry in the simplified form of the critical document register 10 of FIG. 9 is an indication (“Action Complete”) as to whether any such listed action has been carried out.

Once any actions required to address low document maturity have been carried out and duly indicated thus in the critical document register 10, the instigator operator/module assesses the document as to its fitness for the purpose of the intended use of the instigator. The assessment may be provided in any appropriate scaling form, e.g. as a percentage, or, as in this embodiment, as on of three levels I, II and III, where level I indicates fully suitable for purpose, level II indicates acceptable for purpose but not fully suitable, and level III indicates inadequate for purpose. Thus, as shown in the simplified form of the critical document register 10 of FIG. 9, for each document, a further entry is the fit for purpose level i.e. I, II or III (“Fit for Purpose level (I/II/III))”. It is noted that the instigator assesses this according to its requirements in terms of content as well as maturity, and hence there is accordingly not necessarily any direct correlation between the fit for purpose level and the overall document maturity value.

An EMA may be performed after the critical document register 10 has been completed, or completed to an extent determined as sufficient. Based on the maturity of the information available, such a maturity of the basis of estimate to be used can be performed as part of the process of determining whether the organisation is ready to estimate. This would preferably take into account the nature of the estimate required.

Further details will now be described of the EMA described earlier above. Table 4 below shows a schematic representation of data entries in an EMA as may be used in the above embodiments. A first column of data gives a number of discrete graded levels of EMA value to be allocated to an element, ranging (in this example) from level 1 (lowest maturity assessment) to 9 (highest maturity assessment). A second column of data gives (in this example therefore nine) corresponding different worded criteria. The operator allocates, to any given element, the EMA level whose criteria most closely match the properties of the element under consideration. Data corresponding to this is then input to the estimating system 1 and used elsewhere as appropriate. Use of the EMA allows maturity of elements of the estimate to be assessed objectively and reproducibly, and allows the outcomes to be in a data form that may readily be transformed or used to transform other data. A further optional feature in this embodiment is that ranges of levels may be grouped together, i.e. levels 1 to 3 may be grouped together as “immature” levels, levels 4 to 6 may be grouped together as “intermediate” levels, and levels 7 to 9 may be grouped together as “mature” levels. In this case, some later uses of the data may make use of the exact level value, whereas other uses of the data may make use of the group level.

TABLE 4

| Level | Estimate Based on . . . |
|---|---|
| EMA9 | Precise definition with recorded costs of the exact same |
| | nature to the Estimate required |
| EMA8 | Precise definition with recorded costs for a well defined |
| | similar task to the Estimate required |
| EMA7 | Precise definition with validated metrics for a similar task |
| | to the Estimate required |
| EMA6 | Good definition with metrics for a defined task similar to |
| | the Estimate required |
| EMA5 | Good definition with historical information comparison for a |
| | defined task similar to the Estimate required |
| EMA4 | Defined scope with good historical information comparison to |
| | the Estimate required |
| EMA3 | Defined scope with poor historical data comparison to the |
| | Estimate required |
| EMA2 | Poorly defined scope with poor historical data comparison to |
| | the Estimate required |
| EMA1 | Poorly defined scope with no historical data comparison to |
| | the Estimate required |

Returning now to the earlier description of step s10 of “compile and maintain risk, opportunity and uncertainty evaluation” as described earlier above with reference to FIG. 6, it was noted that in the described embodiment the individual results provided above in steps s82 and s83 were not needed for producing the combined result. However, they may still serve various purposes, as will now be discussed.

To be statistically correct risk, opportunity and uncertainty are preferably modelled as a single system because they co-exist, hence step s84. However, it is sometimes difficult to appreciate in a Monte Carlo analysis where the key drivers are when individual risks and combinations of risks may or may not occur in any single Monte Carlo random simulation (single universe). It aids understanding of the baseline task or solution to analyse bottom up uncertainty in the absence of risks and opportunities, i.e. step s82—this shows whether the basic task is reasonably understood and defined. Similarly by running risks and opportunities as a single model, identification can be made of the overall level of exposure to events or considerations that may or may not occur, whilst appreciating those low probability, high impact risks that have to be managed separately rather than through a general level of contingency, i.e. step s83

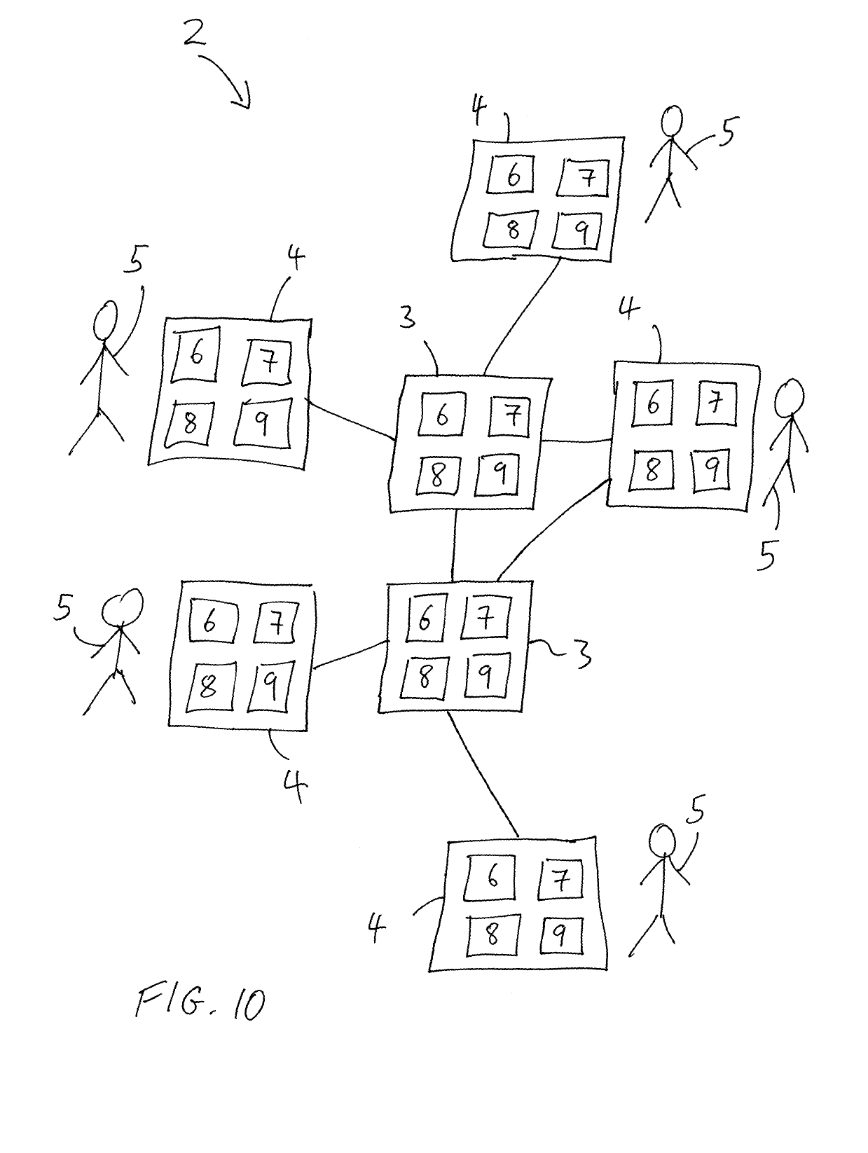

In the above embodiments, the apparatus described above, including the overall estimating system 1, the individual modules 100-700 thereof, and the operator input/output 900, for implementing the above arrangements, and performing the method steps/data transformation described above, are implemented in the form of a server-based computer network 2. The implementation by a networked implementation readily allows more than one individual operator to input data for processing and to allow more than one individual operator to extract and/or receive data results and outcomes (output data). FIG. 10 is a simplified block diagram schematically illustrating the server-based computer network 2. The server-based computer network 2 comprises one or more servers 3 coupled to each other and further coupled to a plurality of operator terminals 4. Each operator terminal 4 may be used by one or more operators 5. Each server 3 and operator terminal 4 comprises the following elements which are all operatively coupled to each other either directly or indirectly: a data store 6, a graphical user interface (GUI) 7, where applicable additional input item 8 such as a mouse and keyboard combination, and a processor 9. The GUI 7 and where applicable additional input item 8 serve in this embodiment as the input/output 900 for the particular terminal 4/operator 5.

More generally, in other embodiments, the apparatus described above, including the overall estimating system 1, the individual modules 100-700 thereof, and the operator input/output 900, for implementing the above arrangements, and performing the method steps/data transformation described above, may be provided by configuring or adapting any suitable apparatus, for example one or more computers or other and apparatus or processors, and/or providing additional modules. The apparatus may comprise a computer, a network of computers, for example a server-based network comprising one or more servers, or one or more processors, for implementing instructions and using data, including instructions and data in the form of a computer program or plurality of computer programs stored in or on a machine readable storage medium such as computer memory, a computer disk, ROM, PROM etc., or any combination of these or other storage media. The apparatus may comprise one or more graphical user interfaces (GUI)s. For example, the use of a networked implementation readily allows more than one individual operator to input data for processing and to allow more than one individual operator to extract and/or receive data results and outcomes (output data).

It should be noted that unless otherwise stated, or inherently impossible, any of the process steps described above may be omitted or such process steps may be performed in differing order to that presented above and shown in the Figures. Furthermore, although all the process steps have, for convenience and ease of understanding, been depicted as discrete temporally-sequential steps, nevertheless some of the process steps may in fact be performed simultaneously or at least overlapping to some extent temporally. Furthermore, for any plural steps where it is clear from the above account that those plural steps effectively do take place simultaneously or at least overlapping to some extent temporally, but have been represented as separate steps in the above account and Figures, it will be appreciated that they have been shown nevertheless as discrete steps for the sake of representing the processes in simple flowchart form.

As is also the case with each other step described below for all of the processes described below for all the above mentioned modules (unless stated otherwise), performance of step s2 may include prompting one or more operators for input data/instructions via the operator input/output 900, and/or otherwise processing and transforming data received via the operator input/output 900, and/or outputting data via the operator input/output 900 for use by one or more operators.

In the above embodiments, the plan and manage module 100 in effect manages the overall estimating process described with reference to FIG. 2. This is in part by virtue of how the overall process of FIG. 2 is iterative in an ongoing sense, for example by the process returning from step s15 to step s2 unless all work is completed. By virtue of its next performance of step s2 the plan and manage module 100 is then able to manage or control which of the other steps will be performed in the next pass though the overall process of FIG. 2. It will be appreciated from the above description that additionally the plan and manage module 100 is able to perform manage and control functions for the overall process if FIG. 2 by influencing decisions made by the other modules by direct interaction with those modules during their carrying out of their respective roles within the overall process of FIG. 2.

In the above embodiments, one or more EMAs may optionally be applied to or at the process of step s2 of planning and managing the estimate process.

Further embodiments of the invention are provided by performing the process of step s85 of reconciling top down and bottom up evaluations with the use of a differing fitting/normalising technique compared to that described above. Any appropriate equations or techniques may be used to fit or normalised a curve derived from assessment of a first estimating approach (the curve being related to the risk and/or opportunity and/or uncertainty of the first estimating approach) to a single or limited number of points derived from assessment of a second differing estimating approach (the single or limited number of points being related to the risk and/or opportunity and/or uncertainty of the second estimating approach). The fitting or normalising may be precise in or approximate.

Further embodiments of the invention are provided by performing the process of step s85 of reconciling top down and bottom up evaluations (including variations as described in the preceding paragraph) to reconcile risk and or opportunity and/or uncertainty of other pairs of differing estimating techniques, for example to other forms of top down and bottom up estimating techniques compared to those described above, or indeed to pairs of differing estimating techniques where one or both of the pairs is neither a top down estimating technique or a bottom up estimating technique.

The above described processes may be applied pre-contract and/or post-contract.

1. Apparatus for use in determining how mature an estimate is by assessing the basis of an estimate against a scale of criteria or categories of plural relative values of maturity of estimate, the apparatus comprising:
a data store configured to store: data defining criteria or categories, and data identifying plural relative values of maturity of estimate, in a manner that provides a correlation between respective defined criteria or categories and respective values of the plural relative values; and
an input/output operatively coupled to the data store and configured to provide the stored data to an operator and configured to accept selection input from the operator of one of the plural relative values.

2. Apparatus according to claim 1, comprising:
one or more processors operatively coupled to the data store and/or the input/output, and configured to process an estimate in a manner dependent upon an input relative value.

3. Apparatus according to claim 1, wherein the plural relative values are grouped together into ranges.

4. Apparatus according to claim 3, wherein the ranges are respectively classified as i) immature, ii) intermediate, and iii) mature.

5. Apparatus according to claim 1, wherein the estimate is a cost estimate.

6. A method of determining how mature an estimate is, comprising:
assessing, by an estimating system having a computer network, a basis of an estimate against a scale of criteria or categories of plural relative values of maturity of estimate.

7. A method according to claim 6, wherein the plural relative values are grouped together into ranges.

8. A method according to claim 7, wherein the ranges are respectively classified as i) immature, ii) intermediate, and iii) mature.

9. A method according to claim 6, wherein the method is performed on a whole of a top down estimate.

10. A method according to claim 6, wherein the method is performed on only a part of a top down estimate.

11. A method according to claim 10, wherein the method is performed separately for a plurality of different parts of a top down estimate, and respective results are combined.

12. A method according to claim 6, wherein the method is performed on a whole of a bottom up estimate.

13. A method according to claim 6, wherein the method is performed on only a part of a bottom up estimate.

14. A method according to claim 13, wherein the method is performed separately for a plurality of different parts of a bottom up estimate, and the respective results are combined.

15. A method according to claim 6, wherein the estimate is a cost estimate.

16. Apparatus for reconciling respective confidence levels derived for two different estimating processes for a same estimate, the apparatus comprising:
one or more processors configured to:
fit a confidence level curve derived from assessment of a first estimating process of a first type to a single or limited number of confidence level points derived from assessment of a second estimating process of a second type, the second estimating process type being different than the first estimating process type.

17. Apparatus according to claim 16, wherein the confidence level curve derived from assessment of the first estimating process and the confidence level points derived from assessment of the second estimating process are each related to a same single evaluated confidence variable type selected from the group consisting of:
(i) a respective risk determined for the respective estimating processes;
(ii) a respective opportunity determined for the respective estimating processes; and
(iii) a respective uncertainty determined for the respective estimating processes.

18. Apparatus according to claim 16, wherein the confidence level curve derived from assessment of the first estimating process and the confidence level points derived from assessment of the second estimating process are each related to a same pair of evaluated confidence variable types selected from the group consisting of:
(i) a respective risk and a respective opportunity determined for the respective estimating processes;
(ii) a respective risk and a respective uncertainty determined for the respective estimating processes; and
(ii) a respective opportunity and a respective uncertainty determined for the respective estimating processes.

19. Apparatus according to claim 16, wherein the confidence level curve derived from assessment of the first estimating process and the confidence level points derived from assessment of the second estimating process are each related to a same plurality of evaluated confidence variable types comprising:
(i) a respective risk determined for respective estimating processes;
(ii) a respective opportunity determined for the respective estimating processes; and
(iii) a respective uncertainty determined for the respective estimating processes.

20. Apparatus according to claim 16, wherein the first estimating process is a bottom up type of estimating process.

21. Apparatus according to claim 20, wherein the confidence level curve is of cumulative probability against estimate value.

22. Apparatus according to claim 21, wherein the confidence level curve is determined as a Monte Carlo distribution.

23. Apparatus according to claim 16, wherein the second estimating process is a top down type of estimating process.

24. Apparatus according to claim 16, wherein the single or limited number of confidence level points derived from assessment of the second estimating process of the second type comprises:
two derived confidence level points, one of which is a minimum value.

25. Apparatus according to claim 16, wherein one or more processors are configured to fit by normalising.

26. Apparatus according to claim 16, wherein the estimating processes are cost estimating processes.

27. A method of reconciling respective confidence levels derived for two different estimating processes for a same estimate, the method comprising:
fitting, by an estimating system having a computer network, a confidence level curve derived from assessment of a first estimating process of a first type to a single or limited number of confidence level points derived from assessment of a second estimating process of a second type, the second estimating process type being different than the first estimating process type.

28. A method according to claim 27, wherein the confidence level curve derived from assessment of the first estimating process and the confidence level points derived from assessment of the second estimating process are each related to a same single evaluated confidence variable type selected from the group comprising:
(i) a respective risk determined for the respective estimating processes;
(ii) a respective opportunity determined for the respective estimating processes; and
(iii) a respective uncertainty determined for the respective estimating processes.

29. A method according to claim 27, wherein the confidence level curve derived from assessment of the first estimating process and the confidence level points derived from assessment of the second estimating process are each related to a same pair of evaluated confidence variable types selected from the group comprising:
(i) a respective risk and respective opportunity determined for the respective estimating processes;
(ii) a respective risk and a respective uncertainty determined for the respective estimating processes; and
(ii) a respective opportunity and a respective uncertainty determined for the respective estimating processes.

30. A method according to claim 27, wherein the confidence level curve derived from assessment of the first estimating process and the confidence level points derived from assessment of the second estimating process are each related to a same plurality of evaluated confidence variable types comprising:
(i) a respective risk determined for the respective estimating processes;
(ii) a respective opportunity determined for the respective estimating processes; and
(iii) a respective uncertainty determined for the respective estimating processes.

31. A method according to claim 27, wherein the first estimating process is a bottom up type of estimating process.

32. A method according to claim 31, wherein the confidence level curve is of cumulative probability against estimate value.

33. A method according to claim 32, wherein the confidence level curve is determined as a Monte Carlo distribution.

34. A method according to claim 27, wherein the second estimating process is a top down type of estimating process.

35. A method according to claim 27, wherein the single or limited number of confidence level points derived from assessment of the second estimating process of the second type includes two derived confidence level points, one of which is a minimum value.

36. A method according to claim 27, wherein the fitting comprises normalising.

37. A method according to claim 27, wherein the estimating processes are cost estimating processes.

38. Apparatus for use in controlling an estimating process by systematically reviewing a readiness of a planned estimating process by systematically reviewing a basis of an estimate by assessment of determined maturity level values in a document register, the apparatus comprising:
a data store configured to store data defining the document register; and
an input/output operatively coupled to the data store and configured to receive data for the document register and further configured to output data from the document register.

39. Apparatus according to claim 38, wherein the document register comprises;
data identifying at least one document selected as required by a first operator and to be provided by a second operator; and
the document register comprises maturity level data related to the document, the maturity level data being input by the second operator during operation.

40. Apparatus according to claim 39, wherein the document register comprises:
data indicating a fitness for purpose value for the document, the fitness for purpose data input by the first operator.

41. Apparatus according to claim 39, wherein the maturity level data relates to one or more of the group comprising:
(i) completeness;
(ii) stability;
(iii) consistency; and
(iv) certainty.

42. Apparatus according to claim 38, wherein the documents in the document register comprise:
data relating to one or more of the group consisting of:
(i) data relating to maturity of information available, timescales available and proposed contracting arrangements/price type to be offered;
(ii) data relating to assessments of an estimating resource available;
(iii) data specifying activities which stakeholders need to discharge in order to support and produce the estimate;
(iv) data forming a datum against which the estimating activities can be reviewed and progressed;
(v) data specifying operators to be involved against respective stages of the estimating process;
(vi) data specifying what is being estimated and why;
(vii) data specifying how the estimate is going to be performed; and
(viii) data specifying when actions need to be performed.

43. Apparatus according to claim 38, comprising:
one or more processors operatively coupled to the data store and/or the input/output and configured to begin an estimating process responsive to a planned estimating process being determined as sufficiently ready.

44. Apparatus according to claim 38, comprising:
one or more processors operatively coupled to the data store and/or the input/output and configured to perform one or more actions to make an estimation process sufficiently ready.

45. Apparatus according to claim 38, wherein the planned estimating process is a cost estimating process.

46. A method of controlling an estimating process, the controlling method comprising:
systematically reviewing the readiness of a planned estimating process, the reviewing comprising systematically reviewing a basis of an estimate by assessment of determined maturity level values in a document register; and
responsive to the planned estimating process being determined as being insufficiently ready, changing an estimating plan of the estimate; and
performing the controlling method by an estimating system having a computer network.

47. A method according to claim 46, wherein the document register comprises:
data identifying one or more documents selected as required by a first operator and to be provided by a second operator; and wherein the document register comprises:
maturity level data related to the document, the maturity level data being input by the second operator.

48. A method according to claim 47, wherein the document register comprises:
data indicating a fitness for purpose value for the document, the fitness for purpose data being input by the first operator.

49. A method according to claim 47, wherein the maturity level data relates to one or more of the group comprising:
(i) completeness;
(ii) stability;
(iii) consistency; and
(iv) certainty.

50. A method according to claim 46, wherein documents in the document register comprise data relating to one or more of the group comprising:
(i) data relating to maturity of information available, timescales available and proposed contracting arrangements/price type to be offered;
(ii) data relating to assessments of an estimating resource available;
(iii) data specifying activities which stakeholders need to discharge in order to support and produce the estimate;
(iv) data forming a datum against which estimating activities can be reviewed and progressed;
(v) data specifying operators to be involved against respective stages of the estimating process;
(vi) data specifying what is being estimated and why;
(vii) data specifying how the estimate is going to be performed; and
(viii) data specifying when actions need to be performed.

51. A method according to claim 46, comprising,
beginning the estimating process itself responsive to a planned estimating process being determined as sufficiently ready.

52. A method according to claim 46, wherein changing the estimating plan of the estimate comprises:
performing one or more actions to make the estimation process sufficiently ready.

53. A method according to claim 46, wherein the planned estimating process is a cost estimating process.

54. Apparatus for controlling an estimating process; the apparatus comprising:
one or more processors configured to:
iteratively perform a plurality of different estimate assessment and/or preparation processes; and
control an iteration dependent upon a maturity of a basis of an estimate wherein controlling the iteration comprises one or more of the group comprising:
(i) performing a differing selection of a plurality of estimate assessment and/or preparation processes compared to a previous iteration; and
(ii) performing one or more of the plurality of estimate assessment and/or preparation processes in a modified way compared to how it was performed in a previous iteration.

55. Apparatus according to claim 54, wherein the plurality of different estimate assessment and/or preparation processes comprises at least one bottom up process.

56. Apparatus according to claim 55, wherein the plurality of different estimate assessment and/or preparation processes comprises:
at least one process from one or more of the group of processes comprising:
(i) a validate or challenge process;
(ii) a determination of risk, opportunity and uncertainty process;
(iii) a reconcile and maintain process; and
(iv) a clearance process.

57. Apparatus according to claim 54, wherein the plurality of different estimate assessment and/or preparation processes comprises at least one top down process.

58. Apparatus according to claim 57, wherein the plurality of different estimate assessment and/or preparation processes comprises:
at least one process from one or more of the group of processes comprising:
(i) a validate or challenge process;
(ii) a determination of risk, opportunity and uncertainty process;
(iii) a reconcile and maintain process; and
(iv) a clearance process.

59. Apparatus according to claim 54, wherein the plurality of different estimate assessment and/or preparation processes comprises at least one bottom up process and at least one top down process.

60. Apparatus according to claim 59, wherein the plurality of different estimate assessment and/or preparation processes comprises:
at least one process from one or more of the group of processes comprising:
(i) a validate or challenge process;
(ii) a determination of risk, opportunity and uncertainty process;
(iii) a reconcile and maintain process; and
(iv) a clearance process.

61. Apparatus according to claim 54, wherein the plurality of different estimate assessment and/or preparation processes comprises at least one process from two or more of the group of processes comprising:
(i) a bottom up process;
(ii) a top down process;
(iii) a validate or challenge process;
(iv) a determination of risk, opportunity and uncertainty process;
(v) a reconcile and maintain process; and
(vi) a clearance process.

62. Apparatus according to claim 54, wherein the estimating process is a cost estimating process.

63. Apparatus according to claim 54, for determining how mature an estimate is by assessing the basis of an estimate against a scale of criteria or categories of plural relative values of maturity of estimate; the apparatus comprising:
a data store operatively coupled to the one or more processors and configured to store data defining criteria or categories, and data identifying plural relative values of maturity of estimate, in a manner that provides a correlation between respective defined criteria or categories and respective values of the plural relative values; and
an input/output operatively coupled to the data store and/or the one or more processors and configured to provide the stored data to an operator and further configured to accept selection input from the operator of one of the plural relative values.

64. Apparatus according to claim 54, wherein the one or more processors are configured to fit a confidence level curve derived from assessment of a first estimating process of a first type to a single or limited number of confidence level points derived from assessment of a second estimating process of a second type, the second estimating process type being different to the first estimating process type.

65. Apparatus according to claim 54, for controlling an estimating process by systematically reviewing readiness of a planned estimating process by systematically reviewing the basis of the estimate by assessment of determined maturity level values in a document register, the apparatus further comprising:
a data store operatively coupled to the one or more processors and configured to store data defining the document register; and
an input/output operatively coupled to the data store and/or the one or more processors and configured to receive data for the document register and further configured to output data from the document register.

66. A method of controlling an estimating process, the controlling method comprising:
iteratively performing a plurality of different estimate assessment and/or preparation processes;
controlling an iteration dependent upon a maturity of a basis of an estimate wherein controlling the iteration comprises one or more of the group comprising:
(i) performing a differing selection of a plurality of estimate assessment and/or preparation processes compared to a previous iteration; and
(ii) performing one or more of the plurality of estimate assessment and/or preparation processes in a modified way compared to how it was performed in a previous iteration;
performing the controlling method an estimating system having a computer network.

67. A method according to claim 66, wherein the plurality of different estimate assessment and/or preparation processes comprises at least one bottom up process.

68. A method according to claim 67, wherein the plurality of different estimate assessment and/or preparation processes comprises at least one process from one or more of the group of processes comprising:
(i) a validate or challenge process;
(ii) a determination of risk, opportunity and uncertainty process;
(iii) a reconcile and maintain process; and
(iv) a clearance process.

69. A method according to claim 66, wherein the plurality of different estimate assessment and/or preparation processes comprises at least one top down process.

70. A method according to claim 69, wherein the plurality of different estimate assessment and/or preparation processes comprises:
at least one process from one or more of the group of processes comprising:
(i) a validate or challenge process;
(ii) a determination of risk, opportunity and uncertainty process;
(iii) a reconcile and maintain process; and
(iv) a clearance process.

71. A method according to claim 66, wherein the plurality of different estimate assessment and/or preparation processes comprises at least one bottom up process and at least one top down process.

72. A method according to claim 71, wherein the plurality of different estimate assessment and/or preparation processes further comprises:
at least one process from one or more of the group of processes consisting of comprising:
(i) a validate or challenge process;
(ii) a determination of risk, opportunity and uncertainty process;
(iii) a reconcile and maintain process; and
(iv) a clearance process.

73. A method according to claim 66, wherein the plurality of different estimate assessment and/or preparation processes comprises:
at least one process from two or more of the group of processes comprising:
(i) a bottom up process;
(ii) a top down process;
(iii) a validate or challenge process;
(iv) a determination of risk, opportunity and uncertainty process;
(v) a reconcile and maintain process; and
(vi) a clearance process.

74. A method according to claim 66, wherein the estimating process is a cost estimating process.

75. A method according to claim 66, comprising,
determining how mature an estimate is by assessing the basis of the estimate against a scale of criteria or categories of plural relative values of maturity of estimate.

76. A method according to claim 66, comprising:
reconciling respective confidence levels derived for two different estimating processes for a same estimate, the reconciling comprising fitting, by an estimating system, a confidence level curve derived from assessment of a first estimating process of a first type to a single or limited number of confidence level points derived from assessment of a second estimating process of a second type, the second estimating process type being different to the first estimating process type.

77. A method according to claim 66, comprising:
controlling, by an estimating system, the estimating process, the controlling comprising:
systematically reviewing readiness of a planned estimating process, the reviewing comprising systematically reviewing the basis of the estimate by assessment of determined maturity level values in a document register; and
responsive to a planned estimating process being determined as being insufficiently ready, changing an estimating plan of the estimate.
